(19) United States
(12) Patent Application Publication
(10) Pub. No.: US 2026/0164389 A1
(43) Pub. Date: Jun. 11, 2026

(54) METHOD AND APPARATUS FOR HANDLING STORE AND FORWARD CONFIGURATION IN A WIRELESS COMMUNICATION SYSTEM

(71) Applicant: ASUS Technology Licensing Inc., Taipei City (TW)

(72) Inventor: Meng-Hui Ou, Taipei City (TW)

(21) Appl. No.: 19/411,066

(22) Filed: Dec. 5, 2025

Related U.S. Application Data
(60) Provisional application No. 63/730,811, filed on Dec. 11, 2024.

(51) Int. Cl. H04W 60/04; H04W 84/06

(52) U.S. Cl. CPC H04W 60/04; H04W 84/06

(57) ABSTRACT

Methods, systems, and apparatuses are provided for handling Store and Forward (S&F) configurations in a wireless communication system, wherein a method of a User Equipment (UE) comprises transmitting a request message during a first procedure, receiving a response message in a first cell in response to the request message, wherein the response message includes a wait time and a list of satellite identities (IDs), starting a first timer based on the wait time, and determining whether the UE is allowed to attempt the first procedure on the first cell when the first timer is running based on whether the response message is an accept message or a reject message.

### CROSS-REFERENCE TO RELATED APPLICATIONS

The present application claims priority to and the benefit of U.S. Provisional Patent Application Ser. No. 63/730,811, filed Dec. 11, 2024, which is hereby fully incorporated herein by reference.

### FIELD

This disclosure generally relates to wireless communication networks and, more particularly, to a method and apparatus for handling store and forward configurations in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for handling Store and Forward (S&F) configurations in a wireless communication system. As such, a User Equipment (UE) can handle cell access for S&F operations appropriately.

In various embodiments, a method for a UE in a wireless communication system comprises transmitting a request message during a first procedure, receiving a response message in a first cell in response to the request message, wherein the response message includes a wait time and a list of satellite identities (IDs), starting a first timer based on the wait time, and determining whether the UE is allowed to attempt the first procedure on the first cell when the first timer is running based on whether the response message is an accept message or a reject message.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of Figure A-1: Illustration of “normal/default operation” and “S&F operation” modes in a 5G system with satellite access, from 3GPP TR 22.865 V2.0.0.

FIG. 6 is a reproduction of FIG. 5.3.2.1-1: Attach procedure, from 3GPP S2-2413021.

FIG. 7 is a reproduction of FIG. 5.3.3.2-1: E-UTRAN Tracking Area Update without S GW change, from 3GPP S2-2413021.

FIG. 8 is an example diagram illustrating an NTN network, in accordance with embodiments of the present invention.

FIG. 9 is FIG. 4.13.x.1-1: Store and Forward (S&F) Satellite operation, from 3GPP S2-2411675, showing the end-to-end exchange of signaling/data traffic is handled in a sequence of steps reflecting the intermittent availability of the service link when the satellite can exchange data with the UE and of the intermittent availability of the ground link when the satellite can exchange data with the core network, in accordance with embodiments of the present invention.

FIG. 10 is a diagram showing an exemplary first procedure, in accordance with embodiments of the present invention.

FIG. 11 is an example diagram showing indications of first (e.g., mandatory) and second (e.g., advisory) values, in accordance with embodiments of the present invention.

FIG. 12 is an example diagram showing satellites not allowed to access, satellites allowed to access (may be de-prioritized), and satellites allowed to access (may be prioritized), in accordance with embodiments of the present invention.

FIG. 13 is a flow diagram of a method of a UE in a wireless communication system comprising transmitting a request message during a first procedure, receiving a response message in a first cell in response to the request message, starting a first timer based on the wait time, and determining whether the UE is allowed to attempt the first procedure on the first cell when the first timer is running based on whether the response message is an accept message or a reject message, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WIMAX®, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] 3GPP TR 22.865 V2.0.0, “Study on satellite access Phase 3 (Release 19)”; [2] 3GPP TR 23.700-29 V19.0.0, “Study on integration of satellite components in the 5G architecture; Phase 3 (Release 19)”; [3] 3GPP TR 38.821 V16.0.0, “Solutions for NR to support non-terrestrial networks (NTN)”; [4] 3GPP S2-2411675; [5] 3GPP S2-2412119; [6] 3GPP R2-2409674; [7] 3GPP R2-2410049; and [8] 3GPP S2-2413021. The standards and documents listed above are hereby expressly and fully incorporated herein by reference in their entirety.

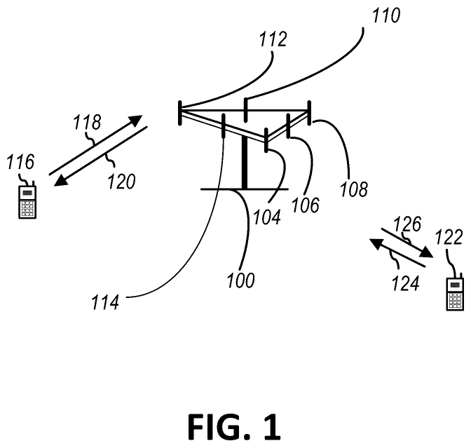

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

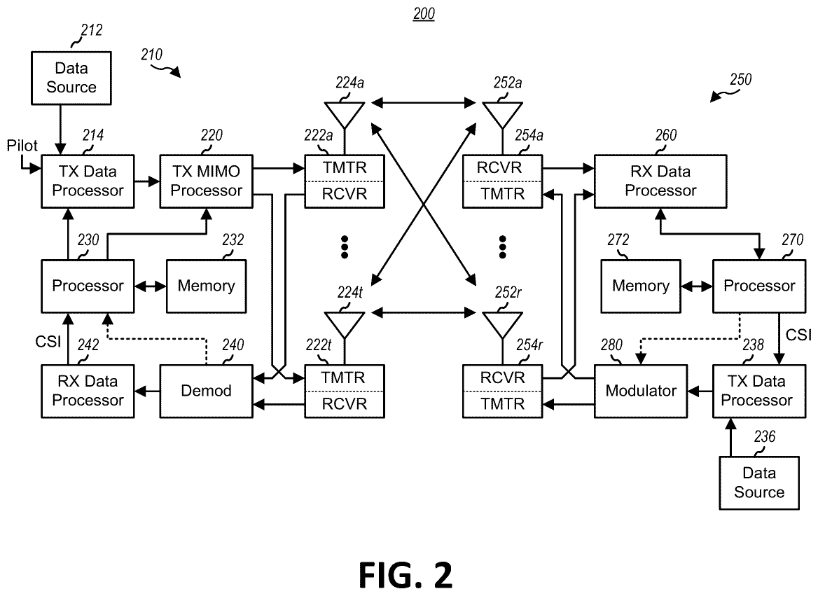

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T}“detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

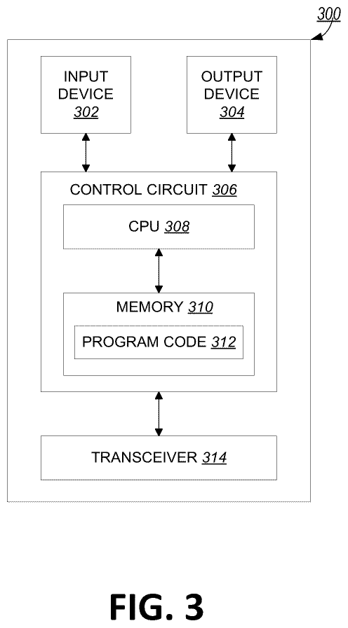

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

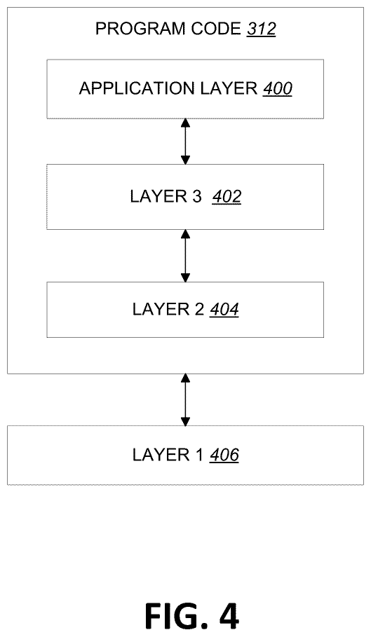

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

In 3GPP TR 22.865 ([1]3GPP TR 22.865 V2.0.0), S&F operation is introduced. The S&F is an operation mode of a 5G system with satellite-access where the 5G system can provide some level of service (in storing and forwarding the data) when satellite connectivity is intermittently/temporarily unavailable, e.g., to provide communication service for UEs under satellite coverage without a simultaneous active feeder link connection to the ground segment.

More details including use cases and potential requirements for S&F operation are also specified in [1] 3GPP TR 22.865 V2.0.0:

### Annex A (Informative):

### Store and Forward Satellite Operation

The Store and Forward Satellite operation in a 5G system with satellite access is intended to provide some level of communication service for UEs under satellite coverage with intermittent/temporary satellite connectivity (e.g. when the satellite is not connected via a feeder link or via ISL to the ground network) for delay-tolerant communication service.

An example of “S&F Satellite operation” is illustrated in Figure A-1, in contrast to what could be considered the current assumption for the “normal/default Satellite operation” of a 5G system with satellite access.

As shown in Figure A-1:
Under “normal/default Satellite operation” mode, signalling and data traffic exchange between a UE with satellite access and the remote ground network requires the service and feeder links to be active simultaneously, so that, at the time that the UE interacts over the service link with the satellite, there is a continuous end-to-end connectivity path between the UE, the satellite and the ground network.
In contrast, under “S&F Satellite operation” mode, the end-to-end exchange of signalling/data traffic is now handled as a combination of two steps not concurrent in time (Step A and B in Figure A-1). In Step A, signalling/data exchange between the UE and the satellite takes place, without the satellite being simultaneously connected to the ground network (i.e. the satellite is able to operate the service link without an active feeder link connection). In Step B, connectivity between the satellite and the ground network is established so that communication between the satellite and the ground network can take place. So, the satellite moves from being connected to the UE in step A to being connected to the ground network in step B.

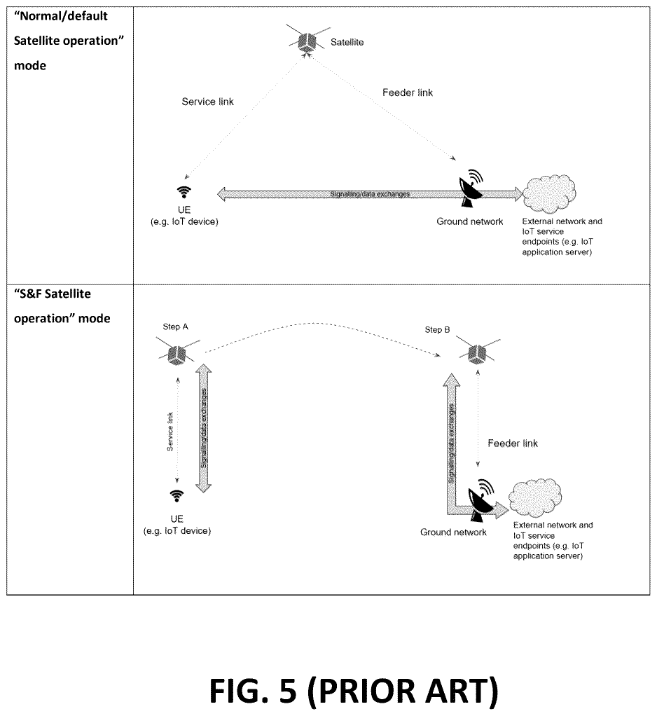

FIG. 5 is a reproduction of Figure A-1: Illustration of “normal/default operation” and “S&F operation” modes in a 5G system with satellite access, from 3GPP TR 22.865 V2.0.0.

The concept of “S&F” service is widely used in the fields of delay-tolerant networking and disruption-tolerant networking. In 3GPP context, a service that could be assimilated to an S&F service is SMS, for which there is no need to have an end-to-end connectivity between the end-points (e.g. an end-point can be a UE and the other an application server) but only between the end-points and the SMSC which acts as an intermediate node in charge of storing and relying.

The support of S&F Satellite operation is especially suited for the delivery of delay-tolerant/non-real-time IoT satellite services with NGSO satellites.

In 3GPP TR 23.700-29 ([2]3GPP TR 23.700-29 V19.0.0), S&F operation is studied:

5.2 Key Issue #2: Support of Store and Forward Satellite operation

### 5.2.1 Description

S&F Satellite operation is especially suited for the delivery of delay-tolerant/non-real-time satellite services (i.e. CIoT/MTC, SMS). To support S&F Satellite operation for such services, it is proposed to study the following items:
If applicable, what are the minimum necessary set of core network elements/network functions that should be placed on board the satellite(s) for the intended service(s);
Whether and how to trigger S&F Satellite operation, and how to execute S&F Satellite operation;
What enhancements on the related UE and network procedures are needed to support S&F Satellite operation, including:
   Whether to inform the UE when the S&F Satellite operation is applied or not.
      8.2 Conclusion for KI #2: Support of Store and Forward Satellite operation

The following option is agreed for supporting Store and Forward operation with a Split MME architecture with the following (informative) principles:
1) In the Split MME architecture, HSS is on the ground.
2) MME functionality is split into two parts: MME-onboard—the MME part which is onboard the satellite and MME-ground—the MME part which is on the ground network with an interface out of scope of 3GPP.
3) The MO data is stored in the MME-onboard when the service link is available and the feeder link is unavailable, and transferred to the ground when the feeder link becomes available. The MT data is stored in the MME-ground or in S-GW when the feeder link is unavailable and transferred to the MME-onboard when the feeder link becomes available. The MT data is stored in the MME-onboard when the feeder link is available and service link is unavailable, and transferred to the UE when service link becomes available. All types of data traffic (e.g. IP, etc.) can be supported and transferred using the existing user plane and control plane procedures defined in EPS.
4) For MO SMS, upon reception of the MO SMS the MME-onboard stores the MO-SMS and may immediately send the delivery report (i.e. RP-ACK) to the UE i.e. as if the MO-SMS has already been successfully delivered to the Service Centre (SC).

With the following normative impacts:
1) When feeder link is not available and the network supports S&F operation, the network shall be able to inform UE(s) whether S&F Satellite operation is applied, (e.g. eNB broadcast support of S&F operation as part of System Information).
NOTE 1: The trigger for the eNB to broadcast support of S&F operation is based on the decision of RAN WGs. From system perspective the expectation is that if the network does not support S&F operation and the feeder link is not available then eNB switches off and does not broadcast any signal.
2) When UE initiates Attach or TAU procedure, it indicates support for S&F mode to the MME following existing NAS capability, the MME sends Attach or TAU Reject message to the UE if these procedures cannot be completed due to S&F operation. The Attach or TAU Reject message includes:
   a) A new information indicating the UE that attach or TAU procedure cannot be completed because of the S&F operation and that the UE can re-attempt the attach or TAU in this PLMN in a next satellite pass. This indicates to the UE that the information contained in the Attach or TAU Request message is stored by the MME and the network will be available to the UE after interaction with ground network.
   b) Wait timer: Indicates to the UE the time it should wait before re-attempting the Attach/TAU procedure in the current or another satellite of the same PLMN.
   c) Optionally, The list of Satellite IDs over which the UE may re-attempt the Attach/TAU procedure, after wait timer expires. The Satellite IDs are based on the SIB information broadcasted by eNB.
3) How the UE process this information is up to UE implementation and during the wait timer the UE can search for another terrestrial or satellite PLMN to get normal service.
4) MME may indicate to HSS the “Request Time”, allowing the HSS to check that no other (e.g. terrestrial) MME has sent an Update Location Request after the “Request Time”, and fetches the authentication vector and other details from HSS following current Authentication and security procedures. The MME may triggers Update location with the HSS and Update location ACK is received by MME. i.e. all the subscription details are retrieved by MME-ground. The Update Location Request includes an indication that this location update is provisional i.e. the HSS must not consider the UE as registered until it receives the final Update Location Request.
5) When the wait timer has expired given to the UE in step 2, if the UE has not successfully attached to another PLMN and the UE finds the cell which broadcast the Satellite ID valid to re-attempt the attach procedure, the UE re-sends the Attach or TAU Request message.
6) During the Attach or TAU procedure with the UE, the MME may also provide a list of Satellite IDs over which the UE may exchange the signalling and data, and a wait-timer that indicates to the UE the time it should wait before attempting signalling and data exchanges in those satellites.
7) The MME may indicate to UE the estimated delivery time in NAS messages (Attach accept or TAU accept message or service accept). How UE uses this information is left for UE implementation.
NOTE 2: The estimated delivery time is the estimated time to send data from the UE to Gateway.
8) The core network can indicate to external SCS/AS whether UE is registered in S&F Mode and the estimated delivery time.
NOTE 3: Whether any existing monitoring events or procedures can be used or enhanced to achieve above will be determined during normative phase.
NOTE 4: SA WG2 will align further based on agreements in SA WG3 e.g. on security procedures and Attach/TAU procedures.

The split MME architecture will be described in informative annex.

The following option is agreed for supporting Store and Forward operation with a full CN onboard the satellite with the following (informative) principles:
The whole CN including eNB, MME, SGW, PGW, HSS, E-SMLC, SMSC etc are onboard each satellite. Proxies are deployed on the satellite and the ground for application traffic, including support of MT traffic, MO traffic, SMS, etc.
The implementation of the proxies and the interface between them is out of 3GPP scope.
The UE attaches, transfers data (e.g. SMS, MO and MT data, etc.) and detaches from each satellite as required and as determined by the monitoring list.
NOTE 5: MT traffic is delivered to the UE after it performs an ATTACH.
NOTE 6: After mobility from S&F operation, MT traffic could be stuck in the ground proxy and will only be retrieved once the UE goes back to S&F operation.
   For MT traffic, the UE attaches to a satellite and to allow delivery of MO traffic from the user or applications on the UE. A UE, based on implementation, could first wait for an indication from the user or from an application on the UE of pending MT traffic or could wait based on knowledge of when MT traffic may arrive, before performing the attach.
   Depending on the deployment and implementation (i.e. outside the scope of 3GPP in this release), the HSSs on the satellites may be populated with subscription data either for only the UEs that may access satellite or all UEs that may access the satellite.
   Depending on the deployment, the UE may have a USIM enhanced for IOPS, or a USIM dedicated to the satellite network.
NOTE 7: The solution does not support the roaming architectures defined in TS 23.501 [2] or TS 23.401 [5].

With the following normative impacts:
Store and forward is only supported by EPS.
Optionally the MME provides the UE with a S&F monitoring list of satellites IDs, during attach/TAU. The UE uses the satellites in the S&F monitoring list for MO/MT data/signalling with the CN. The S&F monitoring list can be determination by the CN. How network determines the S&F monitoring list is outside the scope of 3GPP in this release of specification.
NOTE 8: The S&F monitoring list may assist the UE in retrieving MT data.
   The UE needs to be aware that a satellite supports S&F mode.
NOTE 9: How the UE is aware that a satellite supports S&F mode of operation depends on RAN.
   A UE may be rejected if the satellite cannot support the UE at this time. The attach reject may provide a timer for the time the UE should wait before reattempting and S&F monitoring list which the UE can attempt attach again.

In [8] 3GPP S2-2413021, the S&F operation is introduced in SA2 specification TS 23.401, including the procedures of attach and TAU:

### 5.3.2.1 E-UTRAN Initial Attach

A UE/user needs to register with the network to receive services that require registration. This registration is described as Network Attachment. The always-on connectivity for UE/users of the EPS may be enabled by establishing a default EPS bearer during Network Attachment. The PCC rules applied to the default EPS bearer may be predefined in the PDN GW and activated in the attachment by the PDN GW itself. The Attach procedure may trigger one or multiple Dedicated Bearer Establishment procedures to establish dedicated EPS bearer(s) for that UE. During the attach procedure, the UE may request for an IP address allocation. Terminals utilising only IETF based mechanisms for IP address allocation are also supported.

During the Initial Attach procedure the Mobile Equipment Identity is obtained from the UE. The MME operator may check the ME Identity with an EIR. The MME passes the ME Identity (IMEISV) to the HSS and to the PDN GW.

During the Initial Attach procedure, if the MME supports SRVCC and if any of the conditions described in step 8 in FIG. 5.3.2.1-1 are satisfied, the MME informs the HSS with the UE SRVCC capability e.g. for further IMS registration.

The E-UTRAN Initial Attach procedure is used for Emergency Attach by UEs that need to perform emergency services but cannot gain normal services from the network. These UEs are in limited service state as defined in TS 23.122 [10].

Also UEs that had attached for normal services and do not have emergency bearers established and are camped on a cell in limited service state (e.g. restricted Tracking Area or not allowed CSG) shall initiate the Attach procedures indicating that the attach is to receive emergency services. UEs that camp normally on a cell, i.e. UEs that are not in limited service state, should initiate normal initial attach when not already attached and shall initiate the UE Requested PDN Connectivity procedure to receive emergency EPS bearer services.

The E-UTRAN Initial Attach procedure is used for RLOS Attach by UEs in limited service state as defined in TS 23.122 [10], as well as UEs attached for normal services but moved to a cell in limited service state (e.g. restricted Tracking Area or not allowed CSG).
NOTE 1: A UE that is emergency or RLOS attached performs initial attach procedure before being able to obtain normal services.

In order to limit load on the network, only when performing an E-UTRAN Attach with a new PLMN (i.e. not the registered PLMN or an equivalent PLMN of the registered PLMN), a UE configured to perform Attach with IMSI at PLMN change (see TS 24.368 [69]) shall identify itself by its IMSI instead of any stored temporary identifier.

This procedure is also used to establish the first PDN connection over E-UTRAN when the UE already has active PDN connections over a non-3GPP access network and wants to establish simultaneous PDN connections to different APNs over multiple accesses.

During the Attach procedure, a Multi-USIM UE may indicate to the MME a Requested IMSI Offset, as described in clause 4.3.33, with the aim of modifying the timing of the Paging Occasions to avoid paging collisions.
NOTE 2: As an exception, during the Attach procedure a Multi-USIM UE implementation can decide to indicate to the MME a Requested IMSI Offset even if it does not know whether the MME supports it.

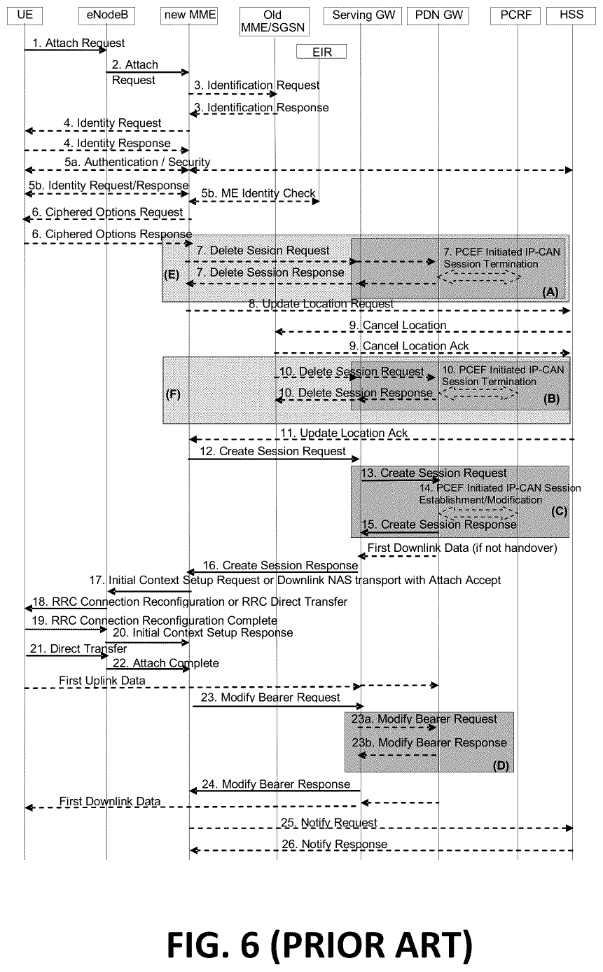

FIG. 6 is a reproduction of FIG. 5.3.2.1-1: Attach procedure, from 3GPP S2-2413021.
Some deployments cannot support all system features, for example they cannot support user plane establishment and user plane data transfer, when operating in S&F Mode in the example split MME deployment as described in Annex X.1. A UE, camping on an E-UTRAN cell reads the related System Information Broadcast.
   An E-UTRAN cell for a PLMN that supports CIoT enhancements shall broadcast:
   For the NB-IoT case:
      Whether it can connect to an MME which supports EPS Attach without PDN Connectivity.
   For the WB-E-UTRAN case:
      Whether it supports Control Plane CIoT EPS Optimisation and it can connect to an MME which supports Control Plane CIoT EPS Optimisation.
      Whether it supports User Plane CIoT EPS Optimisation and it can connect to an MME which supports User Plane CIoT EPS Optimisation.
      Whether it can connect to an MME which supports EPS Attach without PDN Connectivity.
   If the PLMN does not advertise support of EPS attach without PDN connectivity and the UE can only attach without PDN connectivity, then the UE shall not attach to the PLMN in this cell and shall proceed as specified in TS 23.122 [10].
   In the case of WB-E-UTRAN, if the PLMN does not support Control Plane CIoT EPS Optimisation, and the UE only supports Control Plane CIoT EPS Optimisation and cannot otherwise attach, then the UE shall not proceed with the Attach to the PLMN in this cell and shall proceed as specified in TS 23.122 [10].
   An E-UTRAN cell for a PLMN that supports Restricted Local Operator Service shall broadcast:
      Whether it supports Restricted Local Operator Service.
   If the PLMN does not advertise support for Restricted Local Operator Services, the UE shall not proceed with the Attach with indication that the attach is to receive Restricted Local Operator Services to the PLMN in this cell.
   If a Service Gap timer is running in the UE (see clause 4.3.17.9) and the Attach Type is not Emergency Attach and it is not an Attach without PDN connectivity, then the UE shall not send Attach Requests to this PLMN or any other PLMN as long as the timer is running.
   If the UE can proceed to attach, it initiates the Attach procedure by the transmission, to the eNodeB, of an Attach Request (IMSI or old GUTI, Old GUTI type, last visited TAI (if available), UE Core Network Capability, UE Specific DRX parameters, extended idle mode DRX parameters, UE paging probability information, Attach Type, ESM message container (Request Type, PDN Type, Protocol Configuration Options, Ciphered Options Transfer Flag, Header Compression Configuration), KSIASME, NAS sequence number, NAS-MAC, additional GUTI, P-TMSI signature, Voice domain preference and UE's usage setting, Preferred Network behaviour, MS Network Capability, Support for restriction of use of Enhanced Coverage, UE has UE Radio Capability ID assigned for the selected PLMN, Requested IMSI Offset) message together with RRC parameters indicating the Selected Network and the old GUMMEI.
   In the RRC connection establishment signalling associated with the Attach Request, the UE indicates its support of the CIoT EPS Optimisations, relevant for MME selection.
   . . .
   If available, the last visited TAI shall be included in order to help the MME produce a good list of TAIs for any subsequent Attach Accept message. Selected Network indicates the PLMN that is selected for network sharing purposes. The RRC parameter “old GUMMEI” takes its value from the “old GUTI” contained in the Attach Request. UE Network Capability is described in UE capabilities, see clause 5.11.
   . . .
   If a UE indicates support of CIoT EPS Optimisations in the RRC message, it may omit the ESM message container. If the ESM message container is omitted the MME shall not establish a PDN connection as part of the Attach procedure. In this case steps 6, 12 to 16 and 23 to 26 are not executed. In addition, for the case of UEs attaching with Control Plane CIoT EPS Optimisation with no user plane establishment, steps 17 to 22 are replaced by S1 AP NAS Transport and RRC Direct Transfer messages that just transport the NAS Attach Accept and NAS Attach Complete messages.
   Attach Type indicates whether it is an EPS attach or a combined EPS/IMSI attach or an Emergency Attach or an RLOS Attach. Emergency Attach and RLOS Attach shall not be indicated when the UE is using NB-IoT. When using CIoT EPS Optimisations, the UE may indicate EPS attach and request SMS by setting the “SMS transfer without Combined Attach” flag in the Preferred Network Behaviour IE.
   If a UE includes a Preferred Network Behaviour, this defines the Network Behaviour the UE is expecting to be available in the network as defined in clause 4.3.5.10.
   If a UE indicated Control Plane CIoT EPS Optimisation supported in Preferred Network Behaviour, and the UE included the ESM message container, and the PDN type was IPv4 or IPv6 or IPv4v6, and the UE supports header compression, it shall include the Header Compression Configuration. The Header Compression Configuration includes the information necessary for the ROHC channel setup. Optionally, the Header Compression Configuration may include additional header compression context setup parameters if the UE already has the application traffic information, e.g. the target server IP address.
   For an Emergency Attach the UE shall set both the Attach Type and the Request Type to “Emergency” and the IMSI shall be included if the UE does not have a valid GUTI or a valid P-TMSI available. The IMEI shall be included when the UE has no IMSI, no valid GUTI and no valid P-TMSI.
   . . .
2. The eNodeB derives the MME address from the RRC parameters carrying the old GUMMEI, the indicated Selected Network and the RAT (NB-IoT or WB-E-UTRAN). If that MME is not associated with the eNodeB or the old GUMMEI is not available, the eNodeB selects an MME as described in clause 4.3.8.3 on “MME selection function”. The eNodeB forwards the Attach Request message in a S1-MME control message (Initial UE message) together with the Selected Network, CSG access mode, CSG ID, L-GW address, TAI+ECGI of the cell from where it received the message to the new MME. CSG ID is provided if the UE attaches via a CSG cell or hybrid cell. CSG access mode is provided if the UE attaches via a hybrid cell. If the CSG access mode is not provided but the CSG ID is provided, the MME shall consider the cell as a CSG cell. If the eNodeB has a collocated L-GW, it includes the L-GW address in the Initial UE message to the MME.
   . . .
   If the MME is not configured to support Emergency Attach the MME shall reject any Attach Request that indicates Attach Type “Emergency”.
   . . .
   If the UE has included the Preferred Network Behaviour, and what the UE indicated it supports in Preferred Network Behaviour is incompatible with the network support e.g. the UE indicated support only for Control Plane CIoT EPS Optimisation and the MME only supports User Plane CIoT EPS Optimisation, the MME shall reject the Attach Request with an appropriate cause value (e.g. one that avoids retries on this PLMN).
   To assist Location Services, the eNodeB indicates the UE's Coverage Level to the MME.
   If the UE supports MT-EDT as indicated in the UE Network Capability, the MME shall consider this parameter to provide the MT-EDT indication towards Serving GW during PDN Connection establishment or mobility procedures, and handle the data size information that the MME may receive during Downlink Data Notification procedures as defined in clause 5.3.4B.6, and clause 5.3.5B.
   In the case of satellite access for Cellular IoT, the MME may verify the UE location and determine whether the PLMN is allowed to operate at the UE location, as described in clause 4.13.4. If the UE receives an Attach Reject message with cause value indicating that the selected PLMN is not allowed to operate at the present UE location, the UE shall attempt to select a PLMN as specified in TS 23.122 [10].
   If the UE indicated “S&F Capability” in the UE Core Network Capability, the MME may reject the Attach Request and provide the UE with a cause indicating that the UE cannot be provided with store and forward by the satellite. The MME may optionally provide to the UE in the Attach Reject message any of the following: a S&F Wait Timer (see clause 4.13.x).
3. If the UE identifies itself with GUTI and the MME has changed since detach, the new MME determines the type of the old node, i.e. MME or SGSN, as specified in clause 4.3.19, uses the GUTI received from the UE to derive the old MME/SGSN address, and sends an Identification Request (old GUTI, complete Attach Request message) to the old MME/SGSN to request the IMSI. If the request is sent to an old MME, the old MME first verifies the Attach Request message by NAS MAC and then responds with Identification Response (IMSI, MM Context). If the request is sent to an old SGSN, the old SGSN first verifies the Attach Request message by the P-TMSI signature and then responds with Identification Response (MM Context). If the UE is not known in the old MME/SGSN or if the integrity check or P-TMSI signature check for the Attach Request message fails, the old MME/SGSN responds with an appropriate error cause. The MM context contains security related information as well as other parameters (including IMSI) as described in clause 5.7.2 (Information Storage for MME).
   The additional GUTI in the Attach Request message allows the new MME to find any already existing UE context stored in the new MME when the old GUTI indicates a GUTI mapped from a P-TMSI and RAI.
   . . .
4. If the UE is unknown in both the old MME/SGSN and new MME, the new MME sends an Identity Request to the UE to request the IMSI. The UE responds with Identity Response (IMSI).
5a If no UE context for the UE exists anywhere in the network, if the Attach Request (sent in step 1) was not integrity protected, or if the check of the integrity failed, then authentication and NAS security setup to activate integrity protection and NAS ciphering are mandatory. Otherwise it is optional. If NAS security algorithm is to be changed, the NAS security setup is performed in this step. The authentication and NAS security setup functions are defined in clause 5.3.10 on “Security Function”.
   If the UE supports RACS as indicated in the UE Network Capability, and if the UE indicated that it has UE Radio Capability ID assigned for use in the selected PLMN in step 1, then authentication and NAS security setup to activate integrity protection and NAS ciphering are mandatory and the MME shall request the UE to provide the UE Radio Capability ID in Security Mode Command and the UE shall include the UE Radio Capability ID in Security Mode Command Accept for the supported UE radio capabilities.
   For satellite access over NB-IoT, it the UE indicated support for reporting its Coarse Location Information, the MME may request the UE to send its Coarse Location Information by setting the Coarse Location Information Request in the Security Mode Command message and the UE then reports its Coarse Location Information in the Security Mode Complete message to the MME. To perform UE location verification as described in clause 4.13.4, the MME provides the reported Coarse Location Information to the E-SMLC as described in clause 9.1.17 of TS 23.271 [57].
   . . .
5b. The ME Identity (IMEISV) shall be retrieved from the UE. The ME identity shall be transferred encrypted unless the UE performs Emergency Attach or RLOS Attach and cannot be authenticated.
   . . .
6. If the UE has set the Ciphered Options Transfer Flag in the Attach Request message, the Ciphered Options i.e. PCO or APN or both, shall now be retrieved from the UE.
   In order to handle situations where the UE may have subscriptions to multiple PDNs, if the Protocol Configuration Options contains user credentials (e.g. user name/password within PAP or CHAP parameters) then the UE should also send the APN to the MME.
7. If there are active bearer contexts in the new MME for this particular UE (i.e. the UE re-attaches to the same MME without having properly detached before), the new MME deletes these bearer contexts by sending Delete Session Request (LBI) messages to the GWs involved. The GWs acknowledge with Delete Session Response (Cause) message. If a PCRF is deployed, the PDN GW employs an IP-CAN Session Termination procedure to indicate that resources have been released.
8. If the MME has changed since the last detach, or if there is no valid subscription context for the UE in the MME, or if the UE provides an IMSI or the UE provides an old GUTI which doesn't refer to a valid context in the MME, or for some network sharing scenario (e.g. GWCN) if the PLMN-ID of the TAI supplied by the eNodeB is different from that of the GUTI in the UE's context, the MME sends an Update Location Request (MME Identity, IMSI, ME Identity (IMEISV), MME Capabilities, ULR-Flags, Homogeneous Support of IMS Voice over PS Sessions, UE SRVCC capability, equivalent PLMN list) message to the HSS. The MME capabilities indicate the MME's support for regional access restrictions functionality. ULR-Flags indicates “Initial-Attach-Indicator” as this is an Attach procedure. The inclusion of the equivalent PLMN list indicates that the MME supports the inter-PLMN handover to a CSG cell in an equivalent PLMN using the subscription information of the target PLMN. The “Homogenous Support of IMS Voice over PS Sessions” indication (see clause 4.3.5.8A) shall not be included unless the MME has completed its evaluation of the support of “IMS Voice over PS Session” as specified in clause 4.3.5.8.
NOTE 10: At this step, the MME may not have all the information needed to determine the setting of the IMS Voice over PS Session Supported indication for this UE (see clause 4.3.5.8). Hence the MME can send the “Homogenous Support of IMS Voice over PS Sessions” later on in this procedure.
   If the UE performs Initial or Handover Attach in a VPLMN supporting Autonomous CSG Roaming and the HPLMN has enabled Autonomous CSG Roaming in the VPLMN (via Service Level Agreement) and the MME needs to retrieve the CSG subscription information of the UE from the CSS, the MME initiates the Update CSG Location Procedure with CSS as described in clause 5.3.12.
   If the MME determines that only the UE SRVCC capability has changed, the MME sends a Notify Request to the HSS to inform about the changed UE SRVCC capability.
   If there is a valid subscription context for the UE in the MME with a Service Gap timer running and the Attach Type is not Emergency Attach and it is not an Attach without PDN connectivity, the MME rejects the Attach Request from the UE with an appropriate cause value. In addition, MME may also provide a UE with a Mobility Management Back-off Timer set to the remaining value of the Service Gap timer.
   For an Emergency Attach in which the UE was not successfully authenticated, the MME shall not send an Update Location Request to the HSS.
   For an RLOS Attach the MME shall not send an Update Location Request to the HSS.
   When the UE indicated “S&F Capability” in the UE Core Network Capability and MME is operating in S&F Mode, the MME proceeds as follows:
      If the MME has rejected the UE request in step 2, based on configuration the MME may send an Update Location Request including an indication that this is a provisional Update Location Request and may include a timestamp, see clause 4.13.x.
      If the MME has accepted the UE request in step 2, the MME sends an Update Location Request that may include a timestamp, see clause 4.13.x.
9. The HSS sends Cancel Location (IMSI, Cancellation Type) to the old MME. The old MME acknowledges with Cancel Location Ack (IMSI) and removes the MM and bearer contexts. If the ULR-Flags indicates “Initial-Attach-Indicator” and the HSS has the SGSN registration, then the HSS sends Cancel Location (IMSI, Cancellation Type) to the old SGSN. The Cancellation Type indicates the old MME/SGSN to release the old Serving GW resource.
10. If there are active bearer contexts in the old MME/SGSN for this particular UE, the old MME/SGSN deletes these bearer contexts by sending Delete Session Request (LBI) messages to the GWs involved. The GWs return Delete Session Response (Cause) message to the old MME/SGSN. If a PCRF is deployed, the PDN GW employs an IP-CAN Session Termination procedure as defined in TS 23.203 [6] to indicate that resources have been released.
11. The HSS acknowledges the Update Location message by sending an Update Location Ack (IMSI, Subscription data) message to the new MME. The Subscription Data contain one or more PDN subscription contexts. Each PDN subscription context contains an ‘EPS subscribed QoS profile’ and the subscribed APN-AMBR (see clause 4.7.3) and the WLAN offloadability indication (see clause 4.3.23). The new MME validates the UE's presence in the (new) TA.
   . . .
12. If an ESM container was not included in the Attach Request, steps 12, 13, 14, 15, 16 are skipped. If the attach type is not set to “Emergency” or “RLOS”, and the ESM container was included in the Attach Request, and the UE has indicated support for Attach without PDN Connectivity, and the network supports Attach without PDN Connectivity, and the PDN Connection Restriction is set in the subscriber data, then the new MME shall not establish PDN connection, and steps 12, 13, 14, 15 and 16 are skipped.
   . . .
13. The Serving GW creates a new entry in its EPS Bearer table and sends a Create Session Request (IMSI, MSISDN, APN, Serving GW Address for the user plane, Serving GW TEID of the user plane, Serving GW TEID of the control plane, RAT type, Default EPS Bearer QoS, PDN Type, PDN Address, subscribed APN-AMBR, EPS Bearer Identity, Protocol Configuration Options, Handover Indication, ME Identity, User Location Information (ECGI), UE Time Zone, User CSG Information, MS Info Change Reporting support indication, PDN Charging Pause Support indication, Selection Mode, Charging Characteristics, Trace Reference, Trace Type, Trigger Id, OMC Identity, Maximum APN Restriction, Dual Address Bearer Flag, Serving Network, APN Rate Control Status) message to the PDN GW indicated by the PDN GW address received in the previous step. After this step, the Serving GW buffers any downlink packets it may receive from the PDN GW without sending a Downlink Data Notification message to the MME until it receives the Modify Bearer Request message in step 23 below. The MSISDN is included if received from the MME.
   . . .
14. If dynamic PCC is deployed and the Handover Indication is not present, the PDN GW performs an IP-CAN Session Establishment procedure as defined in TS 23.203 [6], and thereby obtains the default PCC rules for the UE. If the UE is accessing over WB-E-UTRA, this may lead to the establishment of a number of dedicated bearers following the procedures defined in clause 5.4.1 in association with the establishment of the default bearer, which is described in Annex F.
   . . .
15. The P-GW creates a new entry in its EPS bearer context table and generates a Charging Id for the Default Bearer. The new entry allows the P-GW to route user plane PDUs between the S-GW and the packet data network, and to start charging. The way the P-GW handles Charging Characteristics that it may have received is defined in TS 32.251 [44].
   The PDN GW returns a Create Session Response (PDN GW Address for the user plane, PDN GW TEID of the user plane, PDN GW TEID of the control plane, PDN Type, PDN Address, EPS Bearer Identity, EPS Bearer QoS, Protocol Configuration Options, Charging Id, Prohibit Payload Compression, APN Restriction, Cause, MS Info Change Reporting Action (Start) (if the PDN GW decides to receive UE's location information during the session), CSG Information Reporting Action (Start) (if the PDN GW decides to receive UE's User CSG information during the session), Presence Reporting Area Action (if the PDN GW decides to receive notifications about a change of UE presence in Presence Reporting Area), PDN Charging Pause Enabled indication (if PDN GW has chosen to enable the function), APN-AMBR, Delay Tolerant Connection) message to the Serving GW.
   . . .
16. The Serving GW returns a Create Session Response (PDN Type, PDN Address, Serving GW address for User Plane, Serving GW TEID User Plane, Serving GW TEID for control plane, EPS Bearer Identity, EPS Bearer QoS, PDN GW addresses and TEIDs (GTP-based S5/S8) or GRE keys (PMIP-based S5/S8) at the PDN GW(s) for uplink traffic, Protocol Configuration Options, Prohibit Payload Compression, APN Restriction, Cause, MS Info Change Reporting Action (Start), Presence Reporting Area Action, CSG Information Reporting Action (Start), APN-AMBR, Delay Tolerant Connection) message to the new MME.
   If Control Plane CIoT EPS Optimisation applies, and if the MME does not include Control Plane Only PDN Connection Indicator in the Create Session Request:
      If separation of S11-U from S1-U is required, the Serving GW shall include the Serving GW IP address and TEID for S11-U and additionally the Serving GW IP address and TEID for S1-U in Create Session Response.
      Otherwise, if separation of S11-U from S1-U is not required, the Serving GW includes the Serving GW IP address and TEID for S11-U in Create Session Response.
17. If an APN Restriction is received, then the MME shall store this value for the Bearer Context and the MME shall check this received value with the stored value for the Maximum APN Restriction to ensure there are no conflicts between values. If the Bearer Context is accepted, the MME shall determine a (new) value for the Maximum APN Restriction. If there is no previously stored value for Maximum APN Restriction, then the Maximum APN Restriction shall be set to the value of the received APN Restriction. MME shall not deactivate bearer(s) with emergency ARP, if present, to maintain valid APN restriction combination.
   The P-GW shall ignore Maximum APN restriction if the request includes the Emergency APN.
   If the MS Info Change Reporting Action (Start) and/or the CSG Information Reporting Action (Start) are received for this bearer context, then the MME shall store this for the bearer context and the MME shall report to that P-GW via the S-GW whenever a UE's location and/or User CSG information change occurs that meets the P-GW request, as described in clause 15.1.1a of TS 23.060 [7]. If Presence Reporting Area Action is received for this bearer context, the MME shall store this information for the bearer context and shall report to that P-GW via the S-GW whenever a change of UE presence in a Presence Reporting Area is detected, as described in clause 5.9.2.2.
   The MME determines the UE AMBR to be used by the eNodeB based on the subscribed UE-AMBR and the APN-AMBR for the default APN, see clause 4.7.3.
   For emergency attach or RLOS attach the MME determines the UE-AMBR to be used by the eNodeB from the APN AMBR received from the S-GW.
   If new MME hasn't received, from Step 12, Voice Support Match Indicator for the UE from the eNodeB then, based on implementation, the MME may set IMS Voice over PS session supported Indication and update it at a later stage.
      The new MME sends an Attach Accept (GUTI, TAI List, Session Management Request (APN, PDN Type, PDN Address, EPS Bearer Identity, Protocol Configuration Options, Header Compression Configuration, Control Plane Only Indicator, Connection Release Supported, Paging Cause Indication for Voice Service Supported, Reject Paging Request Supported, Paging Restriction Supported, Paging Timing Collision Control Supported), NAS sequence number, NAS-MAC, IMS Voice over PS session supported Indication, Emergency Service Support indicator, LCS Support Indication, Supported Network Behaviour, Service Gap Time, Enhanced Coverage Restricted, Indication for support of 15 EPS bearers per UE, PLMN-assigned UE Radio Capability ID, indication for PLMN-assigned UE Radio Capability ID deletion, Accepted IMSI Offset, Forbidden TAI(s), Enhanced Discontinuous Coverage Support, Return To Coverage Notification Not Required, Maximum Time Offset, Start of Unavailability Period, Unavailability Period Duration, Time Reference Information Distribution Indication) message to the eNodeB. GUTI is included if the new MME allocates a new GUTI. PDN Type and PDN Address are omitted if the Attach Request (step 1) did not contain an ESM message container. The MME indicates the CIoT EPS Optimisations it accepts in the Supported Network Behaviour information as defined in clause 4.3.5.10. Service Gap Time is included if Service Gap Time is present in the subscription information (step 11) and the UE has indicated UE Service Gap Control Capability. This message is contained in an S1_MME control message Initial Context Setup Request, unless the MME has selected to use the Control Plane CIoT EPS Optimisation, or, the UE did not include the ESM message container in the Attach Request (step 1), in which case an S1-AP Downlink NAS transport message is used. The S1-AP Initial Context Setup Request message also includes the AS security context information for the UE, the Handover Restriction List, the EPS Bearer QoS, the UE-AMBR, EPS Bearer Identity, as well as the TEID at the Serving GW used for user plane and the address of the Serving GW for user plane and whether User Plane CIoT EPS Optimisation is allowed for the UE. If the PDN type is set to “Non-IP” the MME includes it in the S1-AP Initial Context Setup Request so that the eNodeB disables header compression. If the PDN type is set to “Ethernet” the MME includes it in the S1-AP Initial Context Setup Request so that any eNodeB header compression functionality can act appropriately. In addition, if the PDN connection is established for Local IP Access, the corresponding S1 Initial Context Setup Request message includes a Correlation ID for enabling the direct user plane path between the HeNB and the L-GW. If the PDN connection is established for SIPTO at the Local Network with L-GW function collocated with the (H)eNB, the corresponding S1-AP Initial Context Setup Request message includes a SIPTO Correlation ID for enabling the direct user plane path between the (H)eNB and the L-GW. LIPA and SIPTO do not apply to Control Plane CIoT EPS Optimisation.
NOTE 13: In this release of the 3GPP specification the Correlation ID and SIPTO Correlation ID is set equal to the user plane PDN GW TEID (GTP-based S5) or GRE key (PMIP-based S5) that the MME has received in step 16.
   If Control Plane CIoT EPS Optimisation applies for an IP PDN connection, and the UE has sent in the Attach Request the Header Compression Configuration, and the MME supports the header compression parameters, the MME shall include the Header Compression Configuration in the PDN Connectivity Accept message. The MME also binds the uplink and downlink ROHC channels to support header compression feedback signalling. If the UE has included header compression context setup parameters in Header Compression Configuration in the Attach Request, the MME may acknowledge the header compression context setup parameters. If the ROHC context is not established during the attach procedure for the PDN connection, before using the compressed format for sending the data, the UE and the MME need to establish the ROHC context with ROHC IR packet based on Header Compression Configuration.
   If the MME based on local policy determines the PDN connection shall only use the Control Plane CIoT EPS Optimisation, the MME shall include a Control Plane Only Indicator in the Session Management Request. For PDN connections with an SCEF, the MME shall always include the Control Plane Only Indicator. A UE receiving the Control Plane Only Indicator, for a PDN connection shall only use the Control Plane CIoT EPS Optimisation for this PDN connection.
   If the ESM container was not included in the Attach Request in step 1, then the Attach Accept message shall not include PDN related parameters, and the Downlink NAS transfer S1-AP message shall not include Access stratum context related information but may include CSG related information.
   If the attach type is not set to “Emergency”, and the ESM container was included in Attach Request in step 1, and the UE indicated support of Attach without PDN Connection in the Attach Request, and the MME supports Attach without PDN Connection, and PDN connection restriction is set in subscriber data, then the MME shall discard the ESM container in the Attach Request message, and shall not include PDN related parameters in the Attach Accept, but may include CSG related information.
   In the Attach Accept message, the MME does not include the IPv6 prefix within the PDN Address. The MME includes the EPS Bearer QoS parameter QCI and APN-AMBR into the Session Management Request. Furthermore, if the UE has UTRAN or GERAN capabilities and the network supports mobility to UTRAN or GERAN, the MME uses the EPS bearer QoS information to derive the corresponding PDP context parameters QoS Negotiated (R99 QoS profile), Radio Priority, Packet Flow Id and TI and includes them in the Session Management Request. If the UE indicated in the UE Network Capability it does not support BSS packet flow procedures, then the MME shall not include the Packet Flow Id. Handover Restriction List is described in clause 4.3.5.7 “Mobility Restrictions”. The MME sets the IMS Voice over PS session supported Indication as described in clause 4.3.5.8. LCS Support Indication indicates whether the network supports the EPC-MO-LR and/or CS-MO-LR as described in TS 23.271 [57]. The MME may include an indication whether the traffic of this PDN Connection is allowed to be offloaded to WLAN, as described in clause 4.3.23. Indication for support of 15 EPS bearers per UE indicates the network support for up to 15 EPS bearers per UE as defined in clause 4.12.
   If the UE initiates the Attach procedure at a hybrid cell, the MME shall check whether the CSG ID is contained in the CSG subscription and is not expired. The MME shall send an indication whether the UE is a CSG member to the RAN along with the S1-MME control message. Based on this information, the RAN may perform differentiated treatment for CSG and non-CSG members.
   If the MME or PDN GW has changed the PDN Type, an appropriate reason cause shall be returned to the UE as described in clause 5.3.1.1. If the UE has indicated PDN type “Non-IP” or “Ethernet”, the MME and PDN GW shall not change PDN type.
   For an emergency attached UE, i.e. for UEs that have only emergency EPS bearers established, there is no AS security context information included in the S1 control messages and there is no NAS level security when the UE cannot be authenticated. The Emergency Service Support indicator informs the UE that Emergency bearer services are supported, i.e. the UE is allowed to request PDN connectivity for emergency services.
   For RLOS attached UEs, i.e. for UEs that have only RLOS PDN connection established, there is no AS security context information included in the S1 control messages and there is no NAS level security when the UE cannot be successfully authenticated.
   If the UE included extended idle mode DRX parameters information element, the MME includes extended idle mode DRX parameters information element if it decides to enable extended idle mode DRX with Paging Time Window length assigned considering Subscribed Paging Time Window (if available) and the local policy.
   Additionally, for a UE using an eNodeB that provides discontinuous coverage (e.g. for satellite access with discontinuous coverage), the MME may consider the use of discontinuous coverage as described in clause 4.13.8.2 when determining extended idle mode DRX parameters.
   If the UE provided the UE paging probability information in Step 1, the MME takes it into account when generating the WUS Assistance Information. If the MME has determined WUS Assistance Information for the UE, the MME shall send the WUS Assistance Information to the UE (see TS 36.300 [5]).
   If the UE included support for restriction of use of Enhanced Coverage in step 1, the MME sends Enhanced Coverage Restricted parameter to the eNodeB in S1-AP Initial Context Set-up Request message. MME also sends Enhanced Coverage Restricted parameter to the UE in the Attach Accept message.
   If the UE has indicated support for dual connectivity with NR in the Attach Request and the UE is not allowed to use NR as Secondary RAT, the MME indicates that to the UE in the Attach Accept message.
. . . If the MME receives multiple TAIs from E-UTRAN in step 2 and determines that some, but not all, TAIs in the received list of TAIs are forbidden by subscription or by operator policy, the MME shall include the forbidden TAI(s) in the Attach Accept message.
   If both UE and network support discontinuous coverage, the MME provides the Enhanced Discontinuous Coverage Support indication as described in clause 4.13.8.1. The MME may provide Start of Unavailability Period and/or Unavailability Period Duration to UE in the Attach Accept message as described in clause 4.13.8.2.
   For a UE using a eNodeB that provides discontinuous coverage (e.g. for satellite access with discontinuous coverage), the MME may provide Return To Coverage Notification Not Required, which requests the UE in ECM_IDLE state to not perform the TAU procedure when it returns to coverage as described in clause 4.13.8.2. The MME may also provide a Maximum Time Offset as described in clause 4.13.8.6.
   If supported by the MME and if the UE is subscribed to receive time reference information, then the MME provides the Time Reference Information Distribution Indication to the eNodeB.
   If the UE indicated “S&F Capability” in the UE Core Network Capability and the MME is operating in S&F Mode, the MME may optionally provide to the UE in the Attach Accept message any of the following: a S&F Wait Timer, or an Estimated UL Delivery Time (see clause 4.13.x).
18. If the eNodeB received an S1-AP Initial Context Setup Request the eNodeB sends the RRC Connection Reconfiguration message including the EPS Radio Bearer Identity to the UE, and the Attach Accept message will be sent along to the UE.
   If the eNodeB received an S1-AP Downlink NAS Transport message (e.g. containing the Attach Accept message), the eNode B sends a RRC Direct Transfer message to the UE.
   The UE shall store the QoS Negotiated, Radio Priority, Packet Flow Id and TI, which it received in the Session Management Request, for use when accessing via GERAN or UTRAN. The APN is provided to the UE to notify it of the APN for which the activated default bearer is associated. For further details, see TS 36.331 [37]. The UE may provide EPS Bearer QoS parameters to the application handling the traffic flow(s). The application usage of the EPS Bearer QoS is implementation dependent. The UE shall not reject the RRC Connection Reconfiguration on the basis of the EPS Bearer QoS parameters contained in the Session Management Request.
   If the UE receives Enhanced Coverage Restricted parameter in the Attach Accept message, UE shall store this information and shall use the value of Enhanced Coverage Restricted parameter to determine if enhanced coverage feature should be used or not. If the UE receives a Service Gap Time in the Attach Accept message, the UE shall store this parameter and apply Service Gap Control (see clause 4.3.17.9).
   If the attach procedure is initiated by manual CSG selection and occurs via a CSG cell, the UE upon receiving the Attach accept shall check if the CSG ID and associated PLMN of the cell where the UE has sent the Attach Request message is contained in its Allowed CSG list. If the CSG ID and associated PLMN is not in the UE's Allowed CSG list, the UE shall add the CSG ID and associated PLMN to its Allowed CSG list. Manual CSG selection is not supported when an emergency service has been initiated.
NOTE 14: If the UE receives an Attach Accept message via a hybrid cell, the UE does not add the corresponding CSG ID and associated PLMN to its Allowed CSG list. Adding a CSG ID and associated PLMN to the UE's local Allowed CSG list for a hybrid cell is performed only by OTA or OMA DM procedures.
   When receiving the Attach Accept message the UE shall set its TIN to “GUTI” as no ISR Activated is indicated.
   If the UE receives an IPv4 address set to 0.0.0.0, it may negotiate the IPv4 address with DHCPv4 as specified in TS 29.061 [38]. If the UE receives an IPv6 interface identifier, it may wait for the Router Advertisement from the network with the IPv6 prefix information or it may send a Router Solicitation if necessary.
NOTE 15: The IP address allocation details are described in clause 5.3.1 on “IP Address Allocation”.
   If Control Plane CIoT EPS Optimisation applies or the UE has not included the ESM message container in the Attach Request in step 1, then the steps 19 and 20 are not executed.
19. The UE sends the RRC Connection Reconfiguration Complete message to the eNodeB. For further details, see TS 36.331 [37].
20. The eNodeB sends the Initial Context Response message to the new MME. This Initial Context Response message includes the TEID of the eNodeB and the address of the eNodeB used for downlink traffic on the S i_U reference point.
   The MME shall be prepared to receive this message either before or after the Attach Complete message (sent in step 22).
   If the Correlation ID or SIPTO Correlation ID was included in the Initial Context Setup Request message, the eNodeB shall use the included information to establish direct user plane path with the L-GW and forward uplink data for Local IP Access or SIPTO at the Local Network with L-GW function collocated with the (H)eNB accordingly.
21. The UE sends a Direct Transfer message to the eNodeB, which includes the Attach Complete (EPS Bearer Identity, NAS sequence number, NAS-MAC) message. If the UE omitted the ESM message container from the Attach Request message in step 1, then the EPS Bearer Identity is omitted from the Attach Complete message.
22. The eNodeB forwards the Attach Complete message to the new MME in an Uplink NAS Transport message.
   If the ESM message container was included in step 1, after the Attach Accept message and once the UE has obtained (if applicable to the PDN type) a PDN Address, the UE can then send uplink packets towards the eNodeB which will then be tunneled to the Serving GW and PDN GW. If Control Plane CIoT EPS Optimisations apply, UL data is sent as specified in clause 5.3.4B. If the UE requested for a dual address PDN type (IPv4v6) to a given APN and was granted a single address PDN type (IPv4 or IPv6) by the network with a reason cause indicating that only single IP version per PDN connection is allowed sent together with the PDN type, the UE should request for the activation of a parallel PDN connection to the same APN with a single address PDN type (IPv4 or IPv6) other than the one already activated. If the UE receives no reason cause in step 18 in response to an IPv4v6 PDN type and it receives an IPv6 Interface Identifier apart from the IPv4 address or 0.0.0.0 in the PDN Address field, it considers that the request for a dual address PDN was successful. It can wait for the Router Advertisement from the network with the IPv6 prefix information or it may send Router Solicitation if necessary.
23. Upon reception of both, the Initial Context Response message in step 20 and the Attach Complete message in step 22, the new MME sends a Modify Bearer Request (EPS Bearer Identity, eNodeB address, eNodeB TEID, Handover Indication, Presence Reporting Area Information, RAT type, LTE-M RAT type reporting to PGW) message to the Serving GW. If the Control Plane CIoT EPS Optimisation applies and the PDN connection is not served by a SCEF and if the MME does not need to report a change of UE presence in Presence Reporting Area, sending of Modify Bearer Request and steps 23a, 23b and 24 are skipped; otherwise if the PDN connection is served by SCEF, steps 23, 24, 25, and 26 are not executed. If the MME has been requested to report a change of UE presence in Presence Reporting Area, the MME includes in this message the Presence Reporting Area Information comprising the PRA identifier(s) and indication(s) on whether the UE is inside or outside the area(s). When receiving the request for reporting change of UE presence in Presence Reporting Area, and the MME decides not to activate reporting UE presence in one or more of the received Presence Reporting Area(s), the MME reports also the inactive Presence Reporting Area(s) in this message. The RAT type information element is included if the UE is using the LTE-M RAT type. If PDN GW expects the LTE-M RAT type reporting as specified in clause 5.11.5, the MME also includes the LTE-M RAT type reporting to PGW flag to indicate that the Serving GW needs to forward the LTE-M RAT type to the PGW.
23a. If the Handover Indication is included in step 23, the Serving GW sends a Modify Bearer Request (Handover Indication) message to the PDN GW to prompt the PDN GW to tunnel packets from non 3GPP IP access to 3GPP access system and immediately start routing packets to the Serving GW for the default and any dedicated EPS bearers established. If Presence Reporting Area Information is included in step 23, the Serving GW sends a Modify Bearer Request (Presence Reporting Area Information) message to the PDN GW. If the LTE-M RAT type and the LTE-M RAT type reporting to PGW flag were received at step 23, the Serving GW shall include the LTE-M RAT type in the Modify Bearer Request message to the PGW. Otherwise the Serving GW includes RAT type WB-E-UTRAN.
NOTE 16: The PDN GW is expected to handle the uplink packets sent by the UE via 3GPP access after step 22, even if they arrive before path switch in step 23.
NOTE 17: The PDN GW forwards the Presence Reporting Area Information to the PCRF, to the OCS or to both as defined in TS 23.203 [6].
23b. The PDN GW acknowledges by sending Modify Bearer Response to the Serving GW.
24. The Serving GW acknowledges by sending Modify Bearer Response (EPS Bearer Identity) message to the new MME. The Serving GW can then send its buffered downlink packets.
   If there is a “Availability after DDN Failure” monitoring event or a “UE Reachability” monitoring event configured for the UE in the EMM Context of the MME, the MME sends an event notification (see TS 23.682 [74] for further information).
25. After the MME receives Modify Bearer Response (EPS Bearer Identity) message, if Request Type does not indicate handover and an EPS bearer was established and the subscription data indicates that the user is allowed to perform handover to non-3GPP accesses, and if the MME selected a PDN GW that is different from the PDN GW identity which was indicated by the HSS in the PDN subscription context, the MME shall send a Notify Request including the APN and PDN GW identity to the HSS for mobility with non-3GPP accesses. The message shall include information that identifies the PLMN in which the PDN GW is located.
   If the ME identity of the UE has changed and step 8 has not been performed, the MME sends a Notify Request (ME Identity) message to inform the HSS of the updated ME identity.
   For an unauthenticated or roaming UE, if the Request Type of the UE requested connectivity procedure indicates “Emergency”, the MME shall not send any Notify Request to an HSS. For a non-roaming authenticated UE, based on operator configuration (e.g. on whether Voice over WLAN is supported or not by the operator, on whether the operator uses a fixed PDN GW for emergency calls, etc.), if the Request Type indicates “Emergency”, the MME may send a Notify Request to the HSS including the “PDN GW currently in use for emergency services”, which comprises the PDN GW address and an indication that the PDN connection is for emergency services. The HSS shall store it as part of the UE context for emergency services.
   For any UEs, if Request Type of the UE requested connectivity procedure indicates “RLOS”, the MME shall not send any Notify Request to an HSS.
   After step 8, and in parallel to any of the preceding steps, the MME shall send a Notify Request (Homogeneous Support of IMS Voice over PS Sessions) message to the HSS:
      If the MME has evaluated the support of IMS Voice over PS Sessions, see clause 4.3.5.8, and
      If the MME determines that it needs to update the Homogeneous Support of IMS Voice over PS Sessions, see clause 4.3.5.8A.
26. In the case of non-emergency services, the HSS stores the APN and PDN GW identity pair. In the case of emergency services, the HSS stores the “PDN GW currently in use for emergency services”. The HSS then sends a Notify Response to the MME.
NOTE 18: For handover from non-3GPP access, the PDN GW initiates resource allocation deactivation procedure in the trusted/untrusted non-3GPP IP access as specified in TS 23.402 [2].
   5.3.3.2 E-UTRAN Tracking Area Update without S-GW Change

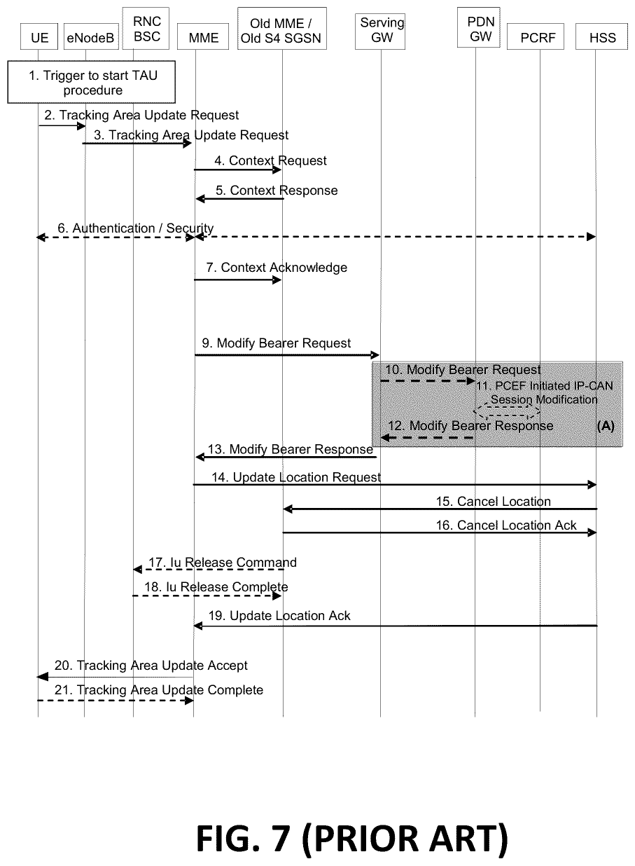

FIG. 7 is a reproduction of FIG. 5.3.3.2-1: E-UTRAN Tracking Area Update without S-GW change, from 3GPP S2-2413021.
NOTE 1: For a PMIP-based S5/S8, procedure steps (A) are defined in TS 23.402 [2]. Steps 12 and 14 concern GTP based S5/S8.
NOTE 2: In the case of Tracking Area Update without MME change the signalling in steps 4, 5, 7 and steps 9-19 are skipped. A change of UE Time Zone, User CSG information or Serving Network is signalled in the next Service Request. If TAI change need to be reported to the PDN GW, location information change reporting procedure described in clause 5.9.2 is performed.
NOTE 3: Deferred reporting of UE Time Zone, or Serving Network per NOTE 2 may fail when inter-MME/SGSN mobility occurs before a UE sends SERVICE REQUEST and the target MME/SGSN (e.g. pre-Release 10) does not support the “Change to Report” flag.
NOTE 4: Some deployments cannot support all system features, for example they cannot support user plane establishment and user plane data transfer, when operating in S&F Mode in the example split MME deployment as described in Annex X.
1. One of the triggers described in clause 5.3.3.0 for starting the TAU procedure occurs.
2. The UE initiates a TAU procedure by sending, to the eNodeB, a Tracking Area Update Request (UE Core Network Capability, MS Network Capability, Preferred Network behaviour, Support for restriction of use of Enhanced Coverage, active flag, signalling active flag, EPS bearer status, old GUTI, Old GUTI Type, last visited TAI, P-TMSI signature, additional GUTI, KSISGSN, KSIASME, NAS sequence number, NAS-MAC, Voice domain preference and UE's usage setting, UE has UE Radio Capability ID assigned for the selected PLMN, Requested IMSI Offset, Release Request indication, Paging Restriction Information, Unavailability Period Duration, Start of Unavailability Period) message together with RRC parameters indicating the Selected Network and the old GUMMEI. An exception is that, if the TAU was triggered for load re-balancing purposes (see clause 4.3.7.3), the old GUMMEI is not included in the RRC parameters. The UE shall set the Old GUTI Type to indicate whether the Old GUTI is a native GUTI or is mapped from a P-TMSI and RAI.
   If the UE's TIN indicates “GUTI” or “RAT-related TMSI” and the UE holds a valid GUTI then the old GUTI indicates this valid GUTI. If the UE's TIN indicates “P-TMSI” and the UE holds a valid P-TMSI and related RAI then these two elements are indicated as the old GUTI. Mapping a P-TMSI and RAI to a GUTI is specified in Annex H. When the UE is in connected mode (e.g. in URA_PCH) when it reselects to E-UTRAN, the UE shall set its TIN to “P-TMSI”.
   If the UE holds a valid GUTI and the old GUTI indicates a GUTI mapped from a P-TMSI and RAI, then the UE indicates the GUTI as additional GUTI. If the old GUTI indicates a GUTI mapped from a P-TMSI and RAI, and the UE has a valid P-TMSI signature, the P-TMSI signature shall be included.
   The additional GUTI in the Tracking Area Update Request message allows the new MME to find any already existing UE context stored in the new MME when the old GUTI indicates a value mapped from a P-TMSI and RAI.
   Alternatively, when a UE only supports E-UTRAN, it identifies itself with the old GUTI and sets the Old GUTI Type to ‘native’.
   . . .
   The last visited TAI shall be included in order to help the MME produce a good list of TAIs for any subsequent TAU Accept message. Selected Network indicates the network that is selected. Active flag is a request by the UE to activate the radio and S1 bearers for all the active EPS Bearers by the TAU procedure. Signalling active flag is a request by UE using Control Plane CIoT EPS Optimisation to maintain the NAS signalling connection after Tracking Area Update Procedure is completed in order to transmit pending Data using the Data Transport in Control Plane CIoT EPS Optimisation or NAS signalling. The UE's ISR capability is included in the UE Core Network Capability element. The EPS bearer status indicates each EPS bearer that is active in the UE. The TAU Request message shall be integrity protected by the NAS-MAC as described in TS 33.401 [41]. KSI_{ASME} is included if the UE has valid security parameters. NAS sequence number indicates the sequential number of the NAS message.
   In the RRC connection establishment signalling associated with the TAU Request, the UE indicates its support of the CIoT EPS Optimisations relevant for MME selection.
   For UE using CIoT EPS Optimisation without any activated PDN connection, there is no active flag or EPS bearer status included in the TAU Request message. For a UE with a running Service Gap timer in the UE the UE shall not set the active flag or the signalling active flag in the TAU request message (see clause 4.3.17.9) except for network access for regulatory prioritized services like Emergency services or exception reporting.
   If the UE has any PDN connection of PDN Type “non-IP” or “Ethernet”, the UE shall send the EPS bearer status in the TAU Request message.
   KSI_{SGSN} is included if the UE indicates a GUTI mapped from a P-TMSI in the information element “old GUTI”.
   The UE sets the voice domain preference and UE's usage setting according to its configuration, as described in clause 4.3.5.9.
   The UE includes extended idle mode DRX parameters information element if it needs to enable extended idle mode DRX, even if extended idle mode DRX parameters were already negotiated before.
   If a UE includes a Preferred Network Behaviour, this defines the Network Behaviour the UE is expecting to be available in the network as defined in clause 4.3.5.10.
   . . .
   If the UE is using a eNodeB that provides discontinuous coverage (e.g. for satellite access with discontinuous coverage), the UE may include an Unavailability Period Duration and Start of Unavailability Period, see clause 4.13.8.2.
3. The eNodeB derives the MME address from the RRC parameters carrying the old GUMMEI, the indicated Selected Network and the RAT (NB-IoT or WB-E-UTRAN). If that GUMMEI is not associated with the eNodeB, or the GUMMEI is not available or the UE indicates that the TAU procedure was triggered by load re-balancing, the eNodeB selects the MME as described in clause 4.3.8.3 on “MME Selection Function”. The eNodeB forwards the TAU Request message together with the CSG access mode, CSG ID, TAI+ECGI of the cell from where it received the message and with the Selected Network to the MME. CSG ID is provided by RAN if the UE sends the TAU Request message via a CSG cell or a hybrid cell. CSG access mode is provided if the UE sends the TAU Request message via a hybrid cell. If the CSG access mode is not provided but the CSG ID is provided, the MME shall consider the cell as a CSG cell. For SIPTO at the Local Network with stand-alone GW architecture the eNodeB includes the Local Home Network ID in the Initial UE Message and in Uplink NAS Transport message if the target cell is in a Local Home Network.
   To assist Location Services, the eNodeB indicates the UE's Coverage Level to the MME.
   If the MME supports RACS, and the MME detects that the selected PLMN is different from the currently registered PLMN for the UE, the MME provides the UE Radio Capability ID of the newly selected PLMN in the UE context to the eNodeB as described in clause 5.11.3a.
   In the case of satellite access for Cellular IoT, the MME may verify the UE location and determine whether the PLMN is allowed to operate at the UE location, as described in clause 4.13.4. If the UE receives a TAU Reject message with cause value indicating that the selected PLMN is not allowed to operate at the present UE location, the UE shall attempt to select a PLMN as specified in TS 23.122 [10].
   If the UE has indicated “S&F Capability” in the UE Core Network Capability and the MME is operating in S&F Mode, if the MME rejects the TAU Request, it may provide a cause indicating that Store and Forward Operation is not supported by the satellite at this time. The MME may optionally provide to the UE any of the following: a S&F Wait Timer (see clause 4.13.x).
4. The new MME differentiates the type of the old node, i.e. MME or SGSN, as specified in clause 4.3.19, uses the GUTI received from the UE to derive the old MME/S4 SGSN address and sends a Context Request (old GUTI, MME Address, UE Validated, complete TAU Request message, P-TMSI Signature, CIoT EPS Optimisation support indication) message to the old MME/S4 SGSN to retrieve the user information. UE Validated indicates that the new MME has validated the integrity protection of the TAU message, e.g. based on native EPS security context for the UE. To validate the Context Request the old MME uses the complete TAU Request message and the old S4 SGSN uses the P-TMSI Signature and responds with an appropriate error if integrity check fails in old MME/S4 SGSN. This shall initiate the security functions in the new MME. If the security functions authenticate the UE correctly, the new MME shall send a Context Request (IMSI, complete TAU Request message, MME Address, UE Validated) message to the old MME/S4 SGSN with the UE Validated set. If the new MME indicates that it has authenticated the UE or if the old MME/old S4 SGSN authenticates the UE, the old MME/old S4 SGSN starts a timer.
   . . .
   If the new MME supports CIoT EPS Optimisation, CIoT EPS Optimisation support indication is included in the Context Request indicating support for various CIoT EPS Optimisations (e.g. support for header compression for CP CIoT EPS Optimisation, etc.).
5. If the Context Request is sent to an old MME the old MME responds with a Context Response (IMSI, ME Identity (IMEISV), unused EPS Authentication Vectors, KSI_{ASME}, K_{ASME}, EPS Bearer Context(s), Serving GW signalling Address and TEID(s), MS Info Change Reporting Action (if available), CSG Information Reporting Action (if available), UE Time Zone, UE Core Network Capability, UE Specific DRX Parameters, Change to Report (if present), Remaining Running Service Gap timer, LTE-M UE Indication) message. If the new MME supports CIoT EPS Optimisation and the use of header compression has been negotiated between the UE and old MME, the Context Response also includes the Header Compression Configuration which includes the information necessary for the ROHC channel setup but not the RoHC context itself.
   If the Context Request is sent to an old S4 SGSN the old S4 SGSN responds with a Context Response (IMSI, ME Identity (if available), unused Authentication Quintets, CK, IK, KSI_{SGSN}, EPS Bearer Context(s), Serving GW signalling Address and TEID(s), ISR Supported, MS Info Change Reporting Action (if available), CSG Information Reporting Action (if available), UE Time Zone, UE Core Network Capability, UE Specific DRX Parameters, Change to Report (if present)) message. The Authentication Quintets are maintained by the old S4 SGSN. TS 33.401 [41] gives further details on the transfer of security related information.
   Change to Report flag is included by the old MME or the old S4 SGSN if reporting of change of UE Time Zone, or Serving Network, or both towards Serving GW/PDN GW was deferred by the old MME or old S4 SGSN.
   If the Context Response message did not include IMEISV and the MME does not already store the IMEISV of the UE, the MME shall retrieve the ME Identity (IMEISV) from the UE.
   The PDN GW Address and TEID(s) (for GTP-based S5/S8) or GRE Keys (PMIP-based S5/S8 at the PDN GW(s) for uplink traffic and the TI(s), is part of the EPS Bearer Context. ISR Supported is indicated if the old SGSN and associated Serving GW are capable to activate ISR for the UE.
   . . .
   For UE using CIoT EPS Optimisation without any activated PDN connection, there is no EPS Bearer Context(s) included in the Context Response message.
   Based on the CIoT EPS Optimisation support indication, old MME only transfers the EPS Bearer Context(s) that the new MME supports. If the new MME does not support CIoT EPS Optimisation, EPS Bearer Context(s) of non-IP PDN connection are not transferred to the new MME. If the new MME does not support Ethernet PDN Type, EPS Bearer Context(s) of Ethernet PDN type are not transferred to the new MME. If the EPS Bearer Context(s) of a PDN connection has not been transferred, the old MME shall consider all bearers of that PDN connection as failed and release that PDN connection by triggering the MME requested PDN disconnection procedure specified in clause 5.10.3. The buffered data in the old MME is discarded after receipt of Context Acknowledgement.
   If the EPS Bearer Context(s) are to be transferred to the new MME, the old MME also includes the Serving GW IP address and TEID for both S1-U and S11-U, if available.
   If the Old MME is aware the UE is a L7TE-M UE, it provides the L7TE-M UE Indication to the new MME.
6. If the integrity check of TAU Request message (sent in step 2) failed, then authentication is mandatory. The authentication functions are defined in clause 5.3.10 on “Security Function”. Ciphering procedures are described in clause 5.3.10 on “Security Function”. If GUTI allocation is going to be done and the network supports ciphering, the NAS messages shall be ciphered.
   If this TAU request is received for a UE which is already in ECM_CONNECTED state and the PLMN-ID of the TAI sent by the eNodeB in Step 3 is different from that of the GUTI included in the TAU Request message, the MME shall delay authenticating the UE until after Step 21 (TAU Complete message).
NOTE 4: The MME delays the authentication such that the UE first updates its registered PLMN-ID to the new PLMN-ID selected by the RAN during handover. The new PLMN-ID is provided by the MME to the UE as part of the GUTI in the TAU accept message in Step 20. Doing this ensures that the same PLMN-ID is used in the derivation of the Kasme key by both the network and the UE.
   . . .
   In the case of satellite access for NB-IoT, if the UE indicated support for reporting its Coarse Location Information, the MME may request the UE to report its Coarse Location Information by setting the Coarse Location Information Request in the Security Mode Command message and the UE then reports its Coarse Location Information in the Security Mode Complete message to the MME. To perform UE location verification as described in clause 4.13.4, the MME provides the reported Coarse Location Information to the E-SMLC as described in clause 9.1.17 of TS 23.271 [57].
7. If the old node is an old MME the new MME sends a Context Acknowledge message to the old MME. The old MME marks in its context that the information in the GW and the HSS are invalid. This ensures that the MME updates the GWs and the HSS if the UE initiates a TAU procedure back to the MME before completing the ongoing TAU procedure.
NOTE 5: Updating the GWs refers to modification of session(s) on the Serving GW. This will result in successful re-establishment of the S11/S4 tunnel between the MME/SGSN and the Serving GW.
   If the old node is an old S4 SGSN the MME sends a Context Acknowledge (ISR Activated) message to the old SGSN. Unless ISR Activated is indicated by the MME, the old S4 SGSN marks in its context that the information in the GWs is invalid. This ensures that the old S4 SGSN updates the GWs if the UE initiates a RAU procedure back to the old S4 SGSN before completing the ongoing TAU procedure. If ISR Activated is indicated to the old S4 SGSN, this indicates that the old S4 SGSN shall maintain its UE context including authentication quintets and stop the timer started in step 4. In this case, if the Implicit Detach timer is running, the old S4 SGSN shall re-start it with a slightly larger value than the UE's GERAN/UTRAN Deactivate ISR timer. Also, in this case, if the old SGSN has maintained the Serving GW address for user plane and S4 GTP-U TEID, the old SGSN shall remove Serving GW address for user plane and S4 GTP-U TEID locally. When ISR Activated is not indicated and this timer expires the old SGSN deletes all bearer resources of that UE. As the Context Acknowledge from the MME does not include any S-GW change the S4 SGSN does not send any Delete Session Request message to the S-GW. The MME shall not activate ISR if the associated Serving GW does not support ISR.
   If the security functions do not authenticate the UE correctly, then the TAU shall be rejected, and the MME shall send a reject indication to the old MME/old S4 SGSN. The old MME/old S4 SGSN shall continue as if the Identification and Context Request was never received.
   For UE using CIoT EPS Optimisation without any activated PDN connection, the steps 9, 10, 11, 12 and 13 are skipped.
8. Void.
9. If the MME has changed the new MME adopts the bearer contexts received from the old MME/SGSN as the UE's EPS bearer contexts to be maintained by the new MME. The MME establishes the EPS bearer(s) in the indicated order. The MME deactivates the EPS bearers which cannot be established.
   The MME verifies the EPS bearer status received from the UE with the EPS bearer contexts it maintains and releases any network resources related to EPS bearers that are not active in the UE. If there is no bearer context at all, the MME rejects the TAU Request. If the MME has changed the new MME sends a Modify Bearer Request (new MME address and TEID, ISR Activated, RAT type, LTE-M RAT type reporting to PGW flag) message per PDN connection to the Serving GW. If there is no need for the SGW to send the signalling to the PDN GW, the MME may send Modify Access Bearers Request (new MME address and TEID) per UE to the Serving GW to optimise the signalling. The PDN GW address is indicated in the bearer contexts. If indicated, the information ISR Activated indicates that ISR is activated. If it is a mobility from a SGSN to a MME and if the MME supports location information change reporting, the MME shall include the User Location Information (according to the supported granularity) in the Modify Bearer Request, regardless of whether location information change reporting had been requested in the previous RAT by the PDN GW. If it is an inter MME mobility and if the PDN GW requested location information change reporting, the MME includes the User Location Information IE in this message if it is different compared to the previously sent information. If the PDN GW requested User CSG information, the MME also includes the User CSG Information IE in this message. If either the UE Time Zone has changed or Context Response message indicated pending UE Time Zone change reporting (via Change to Report flag), the MME includes the UE Time Zone IE in this message. If either the Serving Network has changed or Context Response message indicated pending Serving Network change reporting (via Change to Report flag) the MME includes the new Serving Network IE in this message. In network sharing scenarios Serving Network denotes the serving core network. If the old node is an old MME at a Tracking Area Update with a MME change ISR Activated shall not be indicated.
NOTE 6: The User CSG Information IE is only sent in step 9 if the “Active flag” is set in the TAU Request message.
   When the Modify Access Bearers Request or Modify Bearer Request does not indicate ISR Activated the S-GW deletes any ISR resources by sending a Delete Bearer Request to the other CN node that has bearer resources on the S-GW reserved.
   If the new MME receives the EPS bearer context with SCEF, then the new MME updates the SCEF as defined in TS 23.682 [74].
   For Control Plane CIoT EPS Optimisation, if the DL data is buffered in the Serving GW, and if this is a Tracking Area Update without MME change and the DL Data Buffer Expiration Time in the MM context for the UE in the MME has not expired, or if this is a Tracking Area Update with MME change and the old MME/old S4-SGSN indicated Buffered DL Data Waiting in the Context Response in step 5, the MME shall also indicate S11-U tunnelling of NAS user data and include its own S11-U IP address and MME DL TEID for DL data forwarding by the SGW in the Modify Bearer Request. The MME may also do so without DL data buffered in the SGW.
   If the UE is using the LTE-M RAT type and the PDN GW expects the LTE-M RAT type reporting as specified in clause 5.11.5, the MME also includes the LTE-M RAT type reporting to PGW flag to indicate to the Serving GW to forward the LTE-M RAT type to the PDN GW.
10. If the RAT type has changed, or the Serving GW has received the User Location Information IE or the UE Time Zone IE or User CSG Information IE and/or the Serving Network IE from the MME in step 9, the Serving GW informs the PDN GW(s) about this information that e.g. can be used for charging, by sending the message Modify Bearer Request (RAT type) per PDN connection to the PDN GW(s) concerned. User Location Information IE and/or UE Time Zone IE and/or User CSG Information IE and/or Serving Network IE are also included if they are present in step 9.
   If the Modify Bearer Request message is not sent because of above reasons and the PDN GW charging is paused, then the SGW shall send Modify Bearer Request message with PDN Charging Pause Stop Indication to inform the PDN GW that the charging is no longer paused. Other IEs are not included in this message.
   If LTE-M RAT type and the LTE-M RAT type reporting to PGW flag were received at step 9, the Serving GW shall include the LTE-M RAT type in the Modify Bearer Request message to the PGW. Otherwise the Serving GW includes RAT type WB-E-UTRAN.
11. If dynamic PCC is deployed, and RAT type information or UE location information needs to be conveyed from the PDN GW to the PCRF, then the PDN GW shall send this information to the PCRF by means of an IP-CAN Session Modification procedure as defined in TS 23.203 [6].
NOTE 7: The PDN GW does not need to wait for the PCRF response, but continues in the next step. If the PCRF response leads to an EPS bearer modification the PDN GW should initiate a bearer update procedure.
12. The PDN GW updates its context field to allow DL PDUs to be routed to the correct Serving GW. PDN GW returns a Modify Bearer Response (MSISDN) to the Serving GW. The MSISDN is included if the PDN GW has it stored in its UE context. If there has been a RAT change towards E-UTRAN and location information change reporting is required and supported in the target MME, the PDN GW shall provide MS Info Change Reporting Action in the Modify Bearer Response.
13. The Serving GW updates its bearer context. If ISR Activated is indicated in step 9 and RAT Type received in step 9 indicates E-UTRAN, then the Serving GW only updates the MME Control Plane Address stored locally and keep the SGSN related information unchanged. Also, in this case, if the Serving GW has maintained the SGSN address for user plane and S4 GTP-U TEID, the Serving GW removes the SGSN address for user plane and S4 GTP-U TEID locally. Otherwise the Serving GW shall update all of the information stored locally for this UE with the related information received from the MME. This allows the Serving GW to route Bearer PDUs to the PDN GW when received from eNodeB. The Serving GW shall return a Modify Bearer Response (Serving GW address and TEID for uplink traffic, MS Info Change Reporting Action) message to the new MME as a response to a Modify Bearer Request message, or a Modify Access Bearers Response (Serving GW address and TEID for uplink traffic) as a response to a Modify Access Bearers Request message. If the Serving GW cannot serve the MME Request in the Modify Access Bearers Request message without S5/S8 signalling other than to unpause charging in the PDN GW or without corresponding Gxc signalling when PMIP is used over the S5/S8 interface, it shall respond to the MME with indicating that the modifications are not limited to S1-U bearers, and the MME shall repeat its request using Modify Bearer Request message per PDN connection.
   When the MME receives the Modify Bearer Response or the Modify Access Bearers Response message, the MME checks if there is a “Availability after DDN Failure” monitoring event or a “UE Reachability” monitoring event configured for the UE in the MME and in such a case sends an event notification (see TS 23.682 [74] for further information).
   For Control Plane CIoT EPS Optimisation, if the MME address and MME DL TEID are provided in step 9, the Serving GW includes Serving GW address and Serving GW UL TEID in the Modify Bearer Response message. The DL data is sent to the MME from the Serving GW.
   The buffered DL data is sent to the UE as described in steps 12-14 of clause 5.3.4B.3.
14. The new MME verifies whether it holds subscription data for the UE identified by the GUTI, the additional GUTI or by the IMSI received with the context data from the old CN node.
   . . .
15. The HSS sends a Cancel Location (IMSI, Cancellation type) message to the old MME with a Cancellation Type set to Update Procedure.
16. When receiving a Cancel Location message and the timer started in step 4 is not running, the old MME removes the MM and bearer contexts. Otherwise, the contexts are removed when the timer expires. It also ensures that the MM context is kept in the old MME for the case the UE initiates another TAU procedure before completing the ongoing TAU procedure to the new MME. The old MME acknowledges with a Cancel Location Ack (IMSI) message.
NOTE 9: ISR Activated is never indicated from new to old MME.
   So an old MME deletes all the bearer resources of the UE in any case when the timer started in step 4 expires, which is independent on receiving a Cancel Location message.
17. When receiving the Context Acknowledge message and if the UE is Iu Connected, the old SGSN sends an Iu Release Command message to the RNC after the timer started in step 4 has expired.
18. The RNC responds with an Iu Release Complete message.
19. The HSS acknowledges the Update Location Request by returning an Update Location Ack (IMSI, Subscription Data) message to the new MME after the cancelling of the old MME context is finished. If all checks are successful, the MME constructs an MM context for the UE. The Subscription Data may contain the CSG subscription data for the registered PLMN and for the equivalent PLMN list requested by MME in step 14.
   The subscription data may contain Enhanced Coverage Restricted parameter. If received from the HSS, MME stores this Enhanced Coverage Restricted parameter in the MME MM context.
   The subscription data may contain Service Gap Time. If received from the HSS, the MME stores this Service Gap Time in the MME MM context for the UE and passes it to the UE in the Tracking Area Update Accept message if the UE has indicated Service Gap Control capability.
   The subscription data may contain Subscribed Paging Time Window parameter that applies to the UEs on a specific RAT, e.g. NB-IoT. If received from the HSS, MME stores this Subscribed Paging Time Window parameter in the MME MM context.
   The subscription data may contain an indication that the UE is subscribed to receive time reference information in access stratum. If received from the HSS, and if supported by the MME, the MME stores this indication in the MME MM context.
   If the UE initiates the TAU procedure at a CSG cell, the new MME shall check whether the CSG ID and associated PLMN is contained in the CSG subscription and is not expired. If the CSG ID and associated PLMN is not present or expired, the MME shall send a Tracking Area Update reject message to the UE with an appropriate cause value. The UE shall remove the CSG ID and associated PLMN from its Allowed CSG list if present.
   If the Update Location is rejected by the HSS, the new MME rejects the TAU Request from the UE with an appropriate cause sent in the TAU Reject message to the UE. In such cases, the new MME releases any local MME EPS Bearer contexts for this particular UE.
20. If due to regional subscription restrictions or access restrictions (e.g. CSG restrictions) (received in update location procedure in step 19) the UE is not allowed to access the TA:
   The MME rejects the Tracking Area Update Request with an appropriate cause to the UE.
   For UEs with emergency EPS bearers, i.e. at least one EPS bearer has an ARP value reserved for emergency services, the new MME accepts the Tracking Area Update Request and deactivates all non-emergency PDN connections as specified in clause 5.10.3. If the Tracking Area Update procedure is initiated in ECM-IDLE state, all non-emergency EPS bearers are deactivated by the Tracking Area Update procedure without bearer deactivation signalling between the UE and the MME.
   If the TAU request message includes Paging Restriction Information, the MME may accept or reject the Paging Restriction Information requested by the UE based on operator policy. If the MME rejects the Paging Restriction Information, the MME removes any stored Paging Restriction Information from the UE context and discards the UE requested Paging Restriction Information. If the MME accepts the Paging Restriction Information from the UE, the MME stores the Paging Restriction Information from the UE in the UE context and then enforces it in the Network Triggered Service Request procedure as described in clause 5.3.4.3. The MME informs the UE about the acceptance/rejection of the requested Paging Restriction Information in the TAU Accept message. If the TAU Request message does not include any Paging Restriction Information, the MME shall delete any stored Paging Restriction Information for this UE and stop restricting paging accordingly.
   If the TAU Request message includes a Release Request indication, the MME does not activate the user plane setup procedure in the subsequent steps and triggers the S1 release procedure as described in clause 5.3.5 after the completion of TAU procedure.
   The MME responds to the UE with a Tracking Area Update Accept (GUTI, TAI-list, EPS bearer status, NAS sequence number, NAS-MAC, ISR Activated, IMS Voice over PS session supported, Emergency Service Support indicator, LCS Support Indication, Supported Network Behaviour, Service Gap Time, Enhanced Coverage Restricted, Indication of support of 15 EPS bearers per UE, PLMN-assigned UE Radio Capability ID, Accepted IMSI Offset, Paging Restriction Information acceptance/rejection, Enhanced Discontinuous Coverage Support, Return To Coverage Notification Not Required, Unavailability Period Duration, the Start of Unavailability Period, Maximum Time Offset) message. If the active flag is set the Handover Restriction List may be sent to eNodeB as eNodeB handles the roaming restrictions and access restrictions in the Intra E-UTRAN case. If the active flag is set in the TAU Request message the user plane setup procedure is activated in conjunction with the TAU Accept message. If this is a Tracking Area Update without MME change and the DL Data Buffer Expiration Time in the MM context for the UE in the MME has not expired, or if this is a Tracking Area Update with MME change and the old MME/old S4-SGSN indicated Buffered DL Data Waiting in the Context Response in step 5, the user plane setup procedure is activated even if the MME did not receive the active flag in the TAU Request message. If the new MME receives the Downlink Data Notification message or any downlink signalling message while the UE is still connected, the user plane setup procedure may be activated even if the new MME did not receive the active flag in the TAU Request message. The procedure is described in detail in TS 36.300 [5]. The message sequence should be the same as for the UE triggered Service Request procedure specified in clause 5.3.4.1 from the step when MME establish the bearers(s). The EPS bearer status indicates the active bearers in the network. The UE removes any internal resources related to bearers not marked active in the received EPS bearer status. If the EPS bearer status information was in the TAU Request, the MME shall indicate the EPS bearer status to the UE. If ISR Activated is indicated to the UE, this indicates that its P-TMSI and RAI shall remain registered with the network and shall remain valid in the UE. At a Tracking Area Update with an MME change ISR Activated shall not be indicated. At a Tracking Area Update without an MME change, if ISR is activated for the UE when the MME receives the Tracking Area Update Request, the MME should maintain ISR by indicating ISR Activated in the Tracking Area Update Accept message. Handover Restriction List is described in clause 4.3.5.7 “Mobility Restrictions”. The MME sets the IMS Voice over PS session supported as described in clause 4.3.5.8.
   For UE using CIoT EPS Optimisation without any activated PDN connection, there is no EPS bearer status included in the TAU Accept message.
   The MME indicates the CIoT EPS Optimisations it supports and prefers in the Supported Network Behaviour information as defined in clause 4.3.5.10.
   If there is a Service Gap timer running for the UE in the MME, the MME shall ignore the active flag and signalling active flag and not perform any of the actions related to these flags except if the TAU Request message has been received when the UE has a PDN connection for emergency bearer services established or is establishing a PDN connection for emergency bearer services or if the UE is configured to use high priority access (AC 11-15) in selected PLMN.
   The MME shall include the Service Gap Time in the TAU Accept message if the UE has indicated Service Gap Control capability and either if Service Gap Time was received in step 19 from HSS in the subscription information or if the Service Gap Time in the subscription information has been updated by HSS User Profile management (i.e. the Insert Subscriber Data procedure in clause 5.3.9.2).
   If the UE included support for restriction of use of Enhanced Coverage in step 1, the MME sends Enhanced Coverage Restricted parameter to the eNodeB in the S1-AP message as defined in clause 4.3.28. The MME also sends the Enhanced Coverage Restricted parameter to the UE in the TAU Accept message. UE shall store Enhanced Coverage Restricted parameter and shall use the value of Enhanced Coverage Restricted parameter to determine if enhanced coverage feature should be used or not.
   If the MME successfully obtained Header Compression Configuration parameters in step 5 it indicates he continued use of previous negotiated configuration to the UE in the Header Compression Context Status for each EPS Bearer of the UE. When Header Compression Context Status indicates that the previous negotiated configuration can no longer be used for some EPS bearers, the UE shall stop performing header compression and decompression when sending or receiving data using Control Plane CIoT EPS Optimisation on these EPS bearers.
   The MME checks if there is a “Availability after DDN Failure” monitoring event or a “UE Reachability” monitoring event configured for the UE in the MME for which an event notification has not yet been sent. In such a case an event notification is sent (see TS 23.682 [74] for further information).
   If the MME did not receive the Voice support match indicator in the MM Context, then the MME may send a UE Radio Capability Match Request to the eNodeB as described in clause 5.3.14. If the MME hasn't received Voice support match indicator from the eNodeB then based on implementation MME may set IMS Voice over PS session supported Indication and update it at a later stage. After step 14, and in parallel to any of the preceding steps, the MME shall send a Notify Request (Homogeneous Support of IMS Voice over PS Sessions) message to the HSS:
      If the MME has evaluated the support of IMS Voice over PS Sessions, see clause 4.3.5.8, and
      If the MME determines that it needs to update the Homogeneous Support of IMS Voice over PS Sessions, see clause 4.3.5.8A.
   The Emergency Service Support indicator informs the UE that Emergency bearer services are supported. LCS Support Indication indicates whether the network supports the EPC-MO-LR and/or CS-MO-LR as described in TS 23.271 [57]. Indication for support of 15 EPS bearers per UE indicates the network supports 15 EPS bearers as defined in clause 4.12.
   When receiving the TAU Accept message and there is no ISR Activated indication the UE shall set its TIN to “GUTI”. When ISR Activated is indicated and the UE's TIN indicates “GUTI” the UE's TIN shall not be changed. When ISR Activated is indicated and the TIN is “P-TMSI” or “RAT-related TMSI” the UE shall set its TIN to “RAT-related TMSI”.
   For an MME change ISR is not activated by the new MME to avoid context transfer procedures with two old CN nodes.
   For an emergency attached UE, emergency ISR is not activated.
   If the TAU procedure is initiated by manual CSG selection and occurs via a CSG cell, the UE upon receiving TAU Accept message shall add the CSG ID and associated PLMN to its Allowed CSG list if it is not already present. Manual CSG selection is not supported if the UE has emergency bearers established.
   If the UE included extended idle mode DRX parameters information element, the MME includes extended idle mode DRX parameters information element in the TAU accept if it decides to enable extended idle mode DRX with Paging Time Window length assigned considering Subscribed Paging Time Window (if available) and the local policy. Additionally, for a UE using an eNodeB that provides discontinuous coverage (e.g. for satellite access with discontinuous coverage), the MME may consider Unavailability Period Duration and/or Start of Unavailability Period as described in clause 4.13.8.2 when determining extended idle mode DRX parameters.
   If the user plane setup is performed in conjunction with the TAU Accept message and the TAU is performed via a hybrid cell, then the MME shall send an indication whether the UE is a CSG member to the RAN along with the S1-MME control message. Based on this information, the RAN may perform differentiated treatment for CSG and non-CSG members.
NOTE 10: If the UE receives a TAU Accept message via a hybrid cell, the UE does not add the corresponding CSG ID and associated PLMN to its Allowed CSG list. Adding a CSG ID and associated PLMN to the UE's local Allowed CSG list for a hybrid cell is performed only by OTA or OMA DM procedures.
   If the UE receives a Service Gap Time in the TAU Accept message, the UE shall store this parameter and apply Service Gap Control (see clause 4.3.17.9).
   If the UE has indicated support for dual connectivity with NR in the TAU Request and the UE is not allowed to use NR as Secondary RAT, the MME indicates that to the UE in the TAU Accept message.
   . . .
   If both UE and network support discontinuous coverage, the MME provides the Enhanced Discontinuous Coverage Support indication as described in clause 4.13.8.1.
   For a UE using a eNodeB that provides discontinuous coverage (e.g. for satellite access with discontinuous coverage), the MME may provide Return To Coverage Notification Not Required, which requests the UE in ECM_IDLE state to not perform the TAU procedure when it returns to coverage, and/or provide the UE with an Unavailability Period Duration and/or Start of Unavailability Period if available, as described in clause 4.13.8.2.
   The MME may also provide a Maximum Time Offset as described in clause 4.13.8.6.
   If supported by the MME and if the UE is subscribed to receive time reference information, then the MME provides the Time Reference Information Distribution Indication to the eNodeB.
   If the UE indicated “S&F Capability” in the UE Core Network Capability and the MME is operating in S&F Mode, the MME may optionally provide to the UE in the TAU Accept message any of the following: a S&F Wait Timer or an Estimated UL Delivery Time (see clause 4.13.x).
21. If the GUTI was changed, or the MME indicates an Accepted IMSI Offset to the UE in step 20, the UE acknowledges the new GUTI or the Accepted IMSI Offset value by returning a Tracking Area Update Complete message to the MME.
   When the “Active flag” is not set in the TAU Request message and the Tracking Area Update was not initiated in ECM-CONNECTED state, the MME releases the signalling connection with UE, according to clause 5.3.5. For a UE using Control Plane CIoT EPS Optimisation, when the “Signalling active flag” is set, the new MME shall not release the NAS signalling connection with the UE immediately after the TAU procedure is completed.
NOTE 12: The new MME may initiate E-RAB establishment (see TS 36.413 [36]) after execution of the security functions, or wait until completion of the TA update procedure. For the UE, E-RAB establishment may occur any time after the TA update request is sent.
   In the case of a rejected tracking area update operation, due to regional subscription, roaming restrictions, or access restrictions (see TS 23.221 [27] and TS 23.008 [28]) the new MME should not construct an MM context for the UE. In the case of receiving the subscriber data from HSS, the new MME may construct an MM context and store the subscriber data for the UE to optimise signalling between the MME and the HSS. A reject shall be returned to the UE with an appropriate cause and the S1 connection shall be released. Upon return to idle, the UE shall act according to TS 23.122 [10].
   . . .

A Non-Terrestrial Network (NTN) could be considered as a network that provides non-terrestrial access to User Equipment(s) (UE(s)), e.g., by means of an NTN payload embarked on an airborne or space-borne NTN vehicle and an NTN Gateway. NTN may comprise one or more network nodes such as a Next-Generation Radio Access Network (NG-RAN) node or a New Radio (NR) Node B (gNB). The UE may link to, camp on, and/or connect to the NTN network for transmission and/or reception.

The NTN may comprise various platforms, including Low Earth Orbit (LEO) satellites, Medium Earth Orbit (MEO) satellites, Highly Elliptical Orbit (HEO) satellites, Geostationary Earth Orbit (GEO) satellites, Geostationary Synchronous Orbit (GSO) satellites, Non-Geostationary Synchronous Orbit (NGSO) satellites, and/or High Altitude Platform Stations (HAPS). A LEO satellite could have an earth-fixed beam (e.g., the beam is temporarily fixed on a location during a time period) or an earth-moving beam (e.g., the beam is continuously moving along with the satellite). A LEO satellite could serve/provide earth moving cells (e.g., with an earth-fixed beam) and/or (quasi-)earth fixed cells (e.g., with an earth-moving beam).

The NTN could offer a wide-area coverage and provide Network (NW) access in the scenario when Terrestrial Networks (TNs) are unfeasible (e.g., desert, polar area, and/or on an airplane). More details regarding different NTN platforms could be found in TR 38.821 (e.g., [3] 3GPP TR 38.821 V16.0.0).

A Store and Forward (S&F) operation could be considered as an operation mode of satellite-access providing some level of service (in storing and forwarding the data) when satellite connectivity is intermittently/temporarily unavailable, e.g., to provide communication service for UEs under satellite coverage without a simultaneous active feeder link connection to the ground segment.

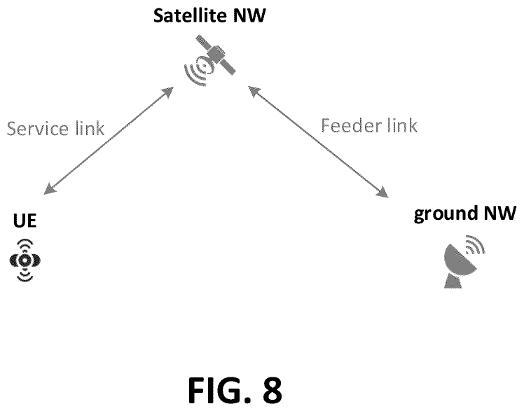

Based on the System Aspects Working Group 2 (SA2) conclusion, the network architecture supporting S&F operation comprises a split Mobile Management Entity (MME) architecture and a full Core Network (CN) onboard architecture. More details can be found in TR 23.700-29 (e.g., [2] 3GPP TR 23.700-29 V19.0.0). For illustration, the network (or network segment(s)) on a satellite may be called a satellite NW. The network (or network segment(s)) on the ground may be called a ground NW. The link/connection/interface between the satellite NW and the ground NW may be referred as a feeder link. The link/connection/interface between the satellite NW and a UE may be referred as a service link. An example is shown in FIG. 8.

A UE could initiate a first procedure (e.g., Attach procedure, Tracking Area Update (TAU) procedure, Service Request procedure) to the network operating in S&F mode. If the first procedure cannot be completed due to S&F, the network may transmit a reject message (e.g., Attach reject, TAU reject) or a response message in response to the request of the UE (e.g., Attach request, TAU request). The reject message or the response message may include a wait timer and/or a list of satellite identities (IDs) (e.g., S&F monitoring list). The UE may start the wait timer (e.g., with the value indicated by the NW in the reject message or the response message). While the wait timer is running, the UE can search for another terrestrial or satellite Public Land Mobile Network (PLMN) to get normal service. When the wait timer has expired, if the UE has not successfully attached to another PLMN and the UE finds the cell which broadcast the Satellite ID valid to re-attempt the first procedure such as an attach procedure (e.g., the satellite ID is included in the list of satellite IDs), the UE could re-send the request message of the first procedure (e.g., Attach or TAU Request message).

In [4] 3GPP S2-2411675, it is proposed to add a new indicator on whether the Wait Timer and the S&F monitoring list are mandatory or advisory to be followed by the UE:

### 4.13.x Support of Store and Forward Satellite Operation

### 4.13.x.1 General

The Store and Forward Satellite Operation applies in Evolved Universal Terrestrial Radio Access Network (E-UTRAN) with satellite access and is suitable for delay-tolerant communication services (e.g., Cellular Internet of Things (CIoT)/Machine Type Communication (MTC), Short Message Service (SMS), etc.). If the satellite does not support Store and Forward Satellite operation and there is no feeder link connection to the ground network, then the satellite cannot provide any service to any UEs. When both the service link and feeder link are available, all services can be provided. To support Store and Forward Satellite operation, some network functionality needs to be deployed on the satellite payload.

Example deployments are described in Annex X.

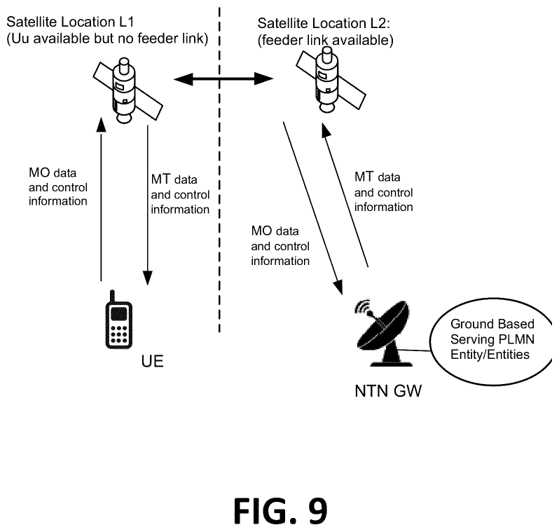

NOTE 1: In FIG. 9 (FIG. 4.13.x.1-1), the NTN Gateway (GW) belongs to the satellite deployment and is not subject to 3GPP specifications.

In Store and Forward Satellite operations, the end-to-end exchange of signaling/data traffic is handled in a sequence of steps reflecting the intermittent availability of the service link when the satellite can exchange data with the UE and of the intermittent availability of the ground link when the satellite can exchange data with the core network. This is depicted in FIG. 9.

For example, a simple sequence of events for the transmission of data from the UE to a server on the ground may involve two steps: firstly, when service link is available (e.g., location L1 in FIG. 9) the UE sends the data to the satellite. Subsequently (e.g., location L2 in FIG. 9), the satellite carrying the payload connects to the ground network and delivers the UE data to the network.

Downlink data can be stored onto the same or a different satellite and be provided to the UE later using the first step, and the process is repeated.

When a satellite supports Store and Forward Satellite operation and is operating in S&F Mode, the onboard E-UTRAN Node B (eNodeB) broadcasts an indication of operating in S&F Mode as described in TS 36.300 (e.g., [5] 3GPP S2-2412119) which the UE uses to determine the current operation mode of the satellite. If a satellite is operating in S&F Mode, and if a UE is Enabled for Store and Forward Satellite operation, then the UE indicates the S&F capability during an Attach and Tracking Area Update.
NOTE 2: Some deployments cannot support all system features, for example they cannot support user plane establishment and user plane data transfer, when operating in S&F Mode in the split MME deployment described in Annex X.

The MME may adapt a periodic update timer and Implicit Detach timer to the fact that the UE is served in S&F mode.

When an MME is operating in S&F Mode:
If the MME cannot complete a Non-Access Stratum (NAS) procedure with the information currently available on the satellite e.g., when the MME does not have UE security context or, if the MME needs to retrieve UE-specific authentication vectors or subscription information from the ground network, it shall reject the NAS procedure. In this case, if the UE supports Store and Forward Satellite operation, the MME shall include a reject cause indicating the NAS rejection is due to S&F operation.
If a UE indicates Store and Forward capability, the MME may also provide to the UE an S&F Wait Timer, or an S&F Monitoring List, or both, and an indication of whether the S&F Wait Timer and/or the S&F Monitoring List is/are mandatory or advisory, when accepting or rejecting a NAS procedure. The S&F Monitoring List is a list of satellites (identified by satellite ID) for the same PLMN with which the UE can attempt to retry the NAS procedure, in the future. The Satellite IDs are based on the System Information Block (SIB) information broadcast by an evolved Node B (eNB).

The S&F Monitoring List sent to the UE during a NAS procedure can be updated by an MME when the UE performs a NAS procedure in the future.
NOTE 3: How the MME determines the S&F Monitoring List and S&F Wait Timer is up to MME implementation, e.g., based on feeder link (un)availability period, service link (un)availability period, UE power saving requirements, Communication Pattern parameters, UE location, UE mobility, etc.

When the S&F Wait Timer expires, the UE may perform a NAS procedure, which can be a subsequent NAS procedure or a reattempt of a NAS procedure previously rejected with a S&F reject cause.

If the S&F Monitoring List was provided to the UE and is indicated as advisory for the UE, the UE uses it as assistance information and,
the UE may (re)attempt a NAS procedure on any of the satellites in the S&F Monitoring List;
the UE can attempt to perform a NAS procedure on the satellites that are part of the S&F Monitoring List and also other satellites that are not part of the S&F Monitoring List.

When the S&F Monitoring List and Wait Timer are indicated to be mandatory, a UE shall not access another satellite until the Wait Timer has expired and when the Wait Timer expires shall not access another satellite that is not part of the S&F Monitoring List.

In [5] 3GPP S2-2412119, it is considered that the list of satellite IDs (as specified in [2] TR 23.700-29) and S&F monitoring list (as specified in [2] TR 23.700-29) are not the same, and proposes to have two separate lists:

| Information Element | Purpose | Comment |
|---|---|---|
| S&F Serving | If provided along with a “Reject cause due to S&F | For the split-MME, this is |
| Satellites List | operation” during a NAS procedure, the UE can | applicable to an scenario |
| | attempt to retry the rejected NAS procedure in any | where a “single MME” is |
| | of the satellites of the selected PLMN listed in the | not deployed in all the |
| | “S&F Serving Satellites List” not later than a | satellites of the |
| | validity timer. | constellation. |
| | If provided during a successful NAS procedure, a | For the full EPC onboard, |
| | UE should consider for subsequent NAS | this could be applicable to a |
| | procedures only the satellites of the selected | scenario where UE |
| | PLMN listed in the “S&F Serving Satellites List”. | credentials are not |
| | A “S&F Serving Satellites List” is valid as long as | provisioned in all the |
| | the UE registration remains valid. | satellites of the |
| | If not provided, the UE could interact with any | constellation. |
| | satellite of the selected PLMN. | |
| S&F Monitoring | If provided during a successful NAS procedure, | |
| Satellites List | UE should only expect MT traffic to be delivered | |
| | through the satellites of the selected PLMN listed | |
| | in the “S&F Monitoring Satellites List”. | |
| | If provided together with the “S&F Serving | |
| | Satellites List”, the “S&F Monitoring Satellites | |
| | List” should be a subset of the former. | |
| | If not provided, the UE should expect MT traffic | |
| | in any of the satellites listed in “S&F Serving | |
| | Satellites List” or, if the latter is not provided | |
| | either, in any of the satellites of the selected | |
| | PLMN. | |

On the other hand, in [6] 3GPP R2-2409674, the following proposals are proposed:

Proposal 1a: If the UE determines that it is out of coverage of all target satellite(s) indicated by MME, the UE operating in S&F mode needs not perform idle mode tasks related to S&F operation (e.g., cell (re)selection, paging monitoring, etc.). The determination of “in coverage/out of coverage” of a target satellite is up to UE implementation.

Proposal 4: Enhance cell (re-)selection mechanism to ensure that the UE operating in S&F mode (re-)selects a cell belonging to the satellites indicated by MME to camp on (e.g., prioritizing the frequencies served by the indicated satellites, selecting the certain cell which belongs to the indicated satellite to camp on, etc.).

And in [7] GPP R2-2410049, the following proposals are proposed: Proposal 5: When connected to an S&F mode cell, it can be left to UE in Radio Resource Control (RRC) Idle (RRC_IDLE) to periodically search for belier and normal mode cells (i.e., cells with feeder link connection available).

Proposal 6: When in RRC_IDLE and waiting to connect to a S&F mode satellite, it can be left to the UE to prioritize the search for belier and normal mode cells (i.e., cells with feeder link connection available).

However, considering the proposals in SA2 (e.g., [4] 3GPP S2-2411675 and [5] 3GPP S2-2412119), the issues for S&F operation including cell access, cell prioritization, and idle mode tasks skipping, may not be handled as proposed in [6] 3GPP R2-2409674 and [7] 3GPP R2-2410049. How to handle the issues properly should be carefully considered.

In addition to the use case specified in the TR 23.700-29 (e.g., [2] 3GPP TR 23.700-29 V19.0.0) (e.g., lack of security information), another use case of the wait timer may be for partial UE context synchronization (e.g., the UE context has not been synchronized in all the satellites of the deployment), as specified in [4]3GPP S2-2411675. Currently, the wait timer may indicate the time the UE should wait before re-attempting the Attach/TAU procedure in the current or another satellite of the same PLMN. However, if the wait timer is due to UE context synchronization (instead of lack of security information), at least the cell accepting the request should already have the UE context. In this case, the UE should have no issue on accessing the cell (e.g., when the wait timer is running).

At least one or more of the method(s) described below may be considered, e.g., to solve the issue(s).

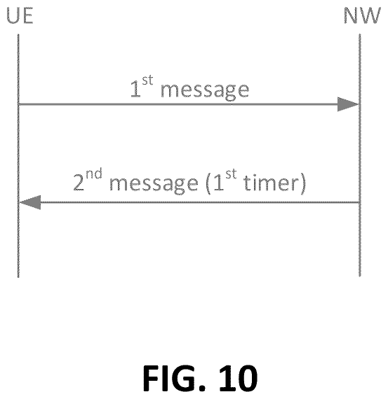

A UE may initiate a first procedure (e.g., to a first network or a first cell). The first procedure may be for S&F operation. The UE may indicate it supports, uses, and/or requests S&F operation during the first procedure. The first procedure may be (or comprise) an attach procedure. The first procedure may be (or comprise) a TAU procedure. The first procedure may be (or comprise) registration procedure. The first procedure may be (or comprise) a service request procedure. The first procedure may be (or comprise) a detach procedure. An example of the first procedure is shown in FIG. 10.

The UE may transmit a first message (e.g., a request message) to a network (e.g., the first network or the first cell), e.g., during the first procedure. The first message may (at least) indicate that the UE supports S&F operation. The first message may (at least) indicate that the UE requests S&F operation. The first message may (at least) indicate a request in S&F operation. The first message may be (or comprise) an attach request. The first message may be (or comprise) a TAU request. The first message may be (or comprise) a registration request. The first message may be (or comprise) a service request. The first message may be (or comprise) a detach request.

The UE may receive a second message (e.g., a response message) from a network (e.g., the first network or the first cell), e.g., during the first procedure, in response to the first message. The second message may (at least) indicate that the network (or the cell) supports S&F operation. The second message may (at least) indicate that the network (or the cell) enables (or activates/starts) the S&F operation. The second message may (at least) indicate that the first message is stored at the (satellite) network, and/or the first message is to be transmitted (or forwarded) to a ground network later (e.g., when a feeder link is available). The second message may (at least) indicate that the network will respond to the UE later (e.g., after the network fetches a response from a ground network). The second message may be (or comprise) an accept message. The second message may be (or comprise) a reject message. The second message may be (or comprise) an accept message. The second message may indicate (or provide information (e.g., a cause value) that indicates) that the first procedure cannot be completed due to the S&F operation.

A wait time (or wait timer) may be included in the second message. The wait time (or wait timer) may indicate the time the UE should wait (or be restricted) before re-attempting the first procedure, e.g., in the current or another satellite of the same PLMN or Tracking Area (TA). The wait time (or wait timer) may indicate how long the UE should wait (or be restricted) for the network to respond (e.g., paging from the network). The wait time (or wait timer) may indicate how long the UE is prohibited (or restricted) to trigger (or initiate) the first procedure (and/or transmit the first message) to the network (e.g., the first network) again (e.g., for S&F). The wait time (or wait timer) may be (or comprise) a time duration (or period).

A list of satellite ID(s) may be included in the second message. The list may indicate one or more satellite(s) over which the UE may re-attempt the first procedure (and/or retransmit the first message), e.g., after (or upon/when/if/in response to) the wait timer (or the first timer) expiring. The list may indicate one or more satellite(s) over which the UE may exchange the signaling and data (and the time it should wait before attempting signaling and data exchanges in those satellites is indicated by the wait time). The list may indicate one or more satellite(s) over which the UE may not re-attempt the first procedure (and/or retransmit the first message) when the first timer is running. The list may indicate one or more satellite(s) over which the UE may exchange data or signaling restricted by the first timer. The list may assist the UE in retrieving Mobile Terminated (MT) data.

The UE may start a first timer (e.g., the wait timer) based on the wait time. The first timer may be started with a value set to the wait time. The first timer may be started in response to receiving the wait time (and/or the second message). The first timer may be a wait timer. The first timer may be a NAS timer. The first timer may be used for S&F operation. The first timer may be used to control when the UE should retry the first procedure (or be excluded from the restriction). The first timer may be used to control how long the UE should wait (or be restricted) before retrying the first procedure. The first timer may be used to control how long the UE is restricted to initiate the first procedure.

When the first timer is running, the UE may be prohibited (or restricted) to initiate (or trigger) the first procedure (and/or transmit the first message) to the (same) network (e.g., for S&F). When the first timer is running, the UE may be prohibited (or restricted) to select another network (e.g., a second network or a second cell) for S&F operation. When the first timer is running, the UE may be allowed to select another network for normal service.

When (or upon/if/after/in response to) the first timer expiring, the UE may initiate (or trigger) the first procedure (and/or transmit the first message) again to the network (e.g., the first network or the first cell), e.g., for S&F operation. When (or upon/if/after/in response to) the first timer expires, the UE may be allowed to initiate (or trigger) the first procedure (and/or transmit the first message) again to the network (e.g., the first network or the first cell), e.g., for S&F operation.

The UE may be capable of using S&F operation. The network may be capable of providing S&F operation.

An indication (or indicator) may be included in the second message. The indication (or indicator) may be provided along with the list of satellite ID(s). The indication (or indicator) may be set to a first value (e.g., mandatory) or a second value (e.g., advisory). The indication (or indicator) may indicate whether the list is mandatory (e.g., when it is set to the first value) or advisory (e.g., when it is set to the second value).

The UE may determine whether to access a cell (e.g., when the first timer is not running, upon/after the first timer expiry, and/or when the first timer is running) based on the indication and/or the list.

For example, if the indication is set to a first value (e.g., mandatory), the UE may not be allowed to access (at least) a first cell. If the indication is set to a second value (e.g., advisory), the UE may be allowed to access (at least) the first cell. The UE may be allowed to access (at least) a second cell regardless of the value of the indication (e.g., either the indication is set to the first value or the second value). The UE may be not allowed to access (at least) a third cell regardless of the value of the indication (e.g., either the indication is set to the first value or the second value).

The UE may determine whether to bar a cell or consider a cell as barred (e.g., when the first timer is not running, upon/after the first timer expiry, and/or when the first timer is running) based on the indication and/or the list.

For example, if the indication is set to a first value (e.g., mandatory), the UE may not consider (at least) a first cell as barred. If the indication is set to a second value (e.g., advisory), the UE may consider (at least) the first cell as barred. The UE may consider (at least) a second cell as barred regardless of the value of the indication (e.g., either the indication is set to the first value or the second value). The UE may not consider (at least) a third cell as barred regardless of the value of the indication (e.g., either the indication is set to the first value or the second value).

The UE may determine whether to consider a cell (e.g., for cell selection and/or reselection) (e.g., when the first timer is not running, upon/after the first timer expiry, and/or when the first timer is running) based on the indication and/or the list.

For example, if the indication is set to a first value (e.g., mandatory), the UE may not consider (at least) a first cell. If the indication is set to a second value (e.g., advisory), the UE may consider (at least) the first cell. The UE may consider (at least) a second cell regardless of the value of the indication (e.g., either the indication is set to the first value or the second value). The UE may consider (at least) a third cell regardless of the value of the indication (e.g., either the indication is set to the first value or the second value).

The UE may determine whether to prioritize or de-prioritize a cell (e.g., for cell selection and/or reselection) (e.g., when the first timer is not running, upon/after the first timer expiry, and/or when the first timer is running) based on the indication and/or the list.

For example, if the indication is set to a first value (e.g., mandatory), the UE may not prioritize (at least) a first cell. If the indication is set to a second value (e.g., advisory), the UE may prioritize (at least) the first cell. The UE may prioritize (at least) a second cell regardless of the value of the indication (e.g., either the indication is set to the first value or the second value). The UE may prioritize (at least) a third cell regardless of the value of the indication (e.g., either the indication is set to the first value or the second value).

For example, if the indication is set to a first value (e.g., mandatory), the UE may not de-prioritize (at least) a first cell. If the indication is set to a second value (e.g., advisory), the UE may de-prioritize (at least) the first cell. The UE may de-prioritize (at least) a second cell regardless of the value of the indication (e.g., either the indication is set to the first value or the second value). The UE may de-prioritize (at least) a third cell regardless of the value of the indication (e.g., either the indication is set to the first value or the second value).

The UE may determine whether to perform (or skip) (one or more) idle mode task(s) (e.g., when the first timer is not running, upon/after the first timer expiry, and/or when the first timer is running) based on the indication and/or the list.

For example, if the indication is set to a first value (e.g., mandatory), the UE may (be allowed to) skip (or not perform) (one or more) idle mode task(s). If the indication is set to a second value (e.g., advisory), the UE may perform (or not skip, or not allowed to skip) (one or more) idle mode task(s). The skipping may depend on whether the UE determines itself in-coverage or out-of-coverage. The determination of in-coverage and/or out-of-coverage may depend on (or be based on) the list, e.g., the coverage provided by the satellite(s) in the list.

For example, when the indication is set to a first value (e.g., mandatory), the UE may perform at least one or more of the following (e.g., when the first timer is not running, upon/after the first timer expiry, and/or when the first timer is running):
The UE may not be allowed to access a first cell (e.g., an NTN cell, a cell in S&F mode, and/or a cell belonging to a satellite not in the list);
The UE may be allowed to access a second cell (e.g., an NTN cell, a cell in S&F mode, and/or a cell belonging to a satellite in the list);
The UE may prioritize a third cell (e.g., a TN cell, a (NTN) cell in normal/default/real-time mode, and/or a cell not belonging to a satellite in the list);
The UE may consider that the third cell is prioritized (e.g., over the second cell);
The UE may not consider that the second cell is prioritized (e.g., over the first cell);
and/or
The UE may not consider that the third cell is prioritized (e.g., over the first cell).

For example, when the indication is set to a second value (e.g., advisory), the UE may perform at least one or more of the following (e.g., when the first timer is not running, upon/after the first timer expiry, and/or when the first timer is running):
The UE may be allowed to access a first cell (e.g., an NTN cell, a cell in S&F mode, and/or a cell belonging to a satellite not in the list);
The UE may de-prioritize the first cell (e.g., an NTN cell, a cell in S&F mode, and/or a cell belonging to a satellite not in the list);
The UE may be allowed to access a second cell (e.g., an NTN cell, a cell in S&F mode, and/or a cell belonging to a satellite in the list);
The UE may prioritize a third cell (e.g., a TN cell, a (NTN) cell in normal/default/real-time mode, and/or a cell not belonging to a satellite in the list);
The UE may consider that the third cell is prioritized (e.g., over the second cell);
The UE may consider that the second cell is prioritized (e.g., over the first cell); and/or
The UE may consider that the third cell is prioritized (e.g., over the first cell).

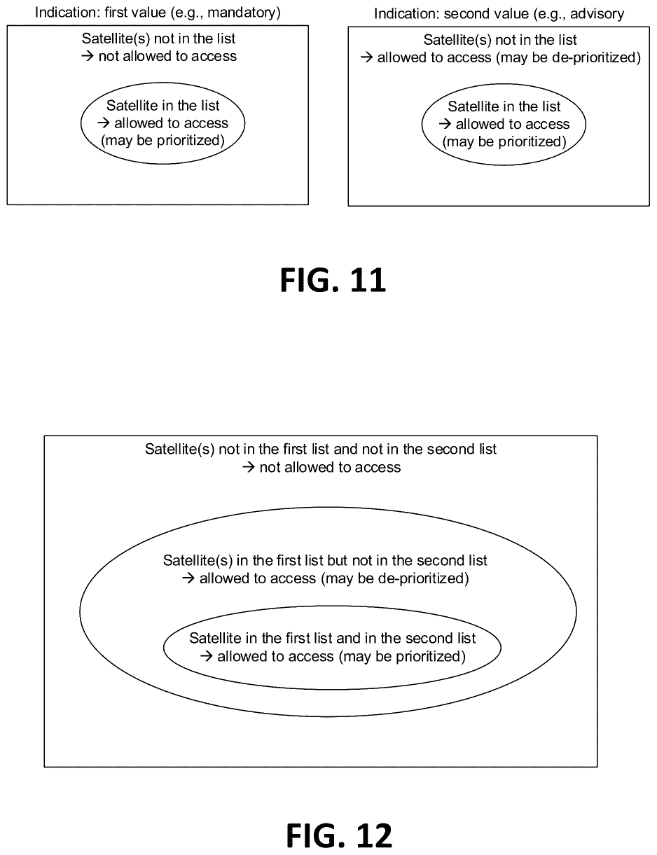

An example is shown in FIG. 11.

The first cell and the second cell may be differentiated by whether it is associated to (or belongs to, or corresponds to) a satellite in the list or not. The first cell and the third cell may be differentiated by whether it is associated to (or belongs to, or corresponds to) a satellite in the list or not. The first cell may be a cell of a satellite not in the list. The first cell may be a cell of a satellite in the list. The second cell may be a cell of a satellite in the list. The third cell may be a cell of a satellite in the list. The third cell may not belong to a satellite in the list. The first cell, the second cell, and/or the third cell may be an NTN cell. The third cell may be a TN cell. The first cell may be operating in S&F mode. The second cell or the third cell may be operating in S&F mode. The first cell may be operating in normal mode (or default mode, or real-time mode, or not in S&F mode). The second cell or the third cell may be operating in normal mode (or default mode, or real-time mode, or not in S&F mode).

For example, if (or when) the list is indicated as mandatory (e.g., indicated by the indication), the UE may not (be allowed to) access and/or re-attempt the first procedure on another satellite that is not included in the list when the first timer is not running (and/or after the first timer expires).

For example, if (or when) the list is indicated as mandatory (e.g., indicated by the indication), the UE may not (be allowed to) access and/or re-attempt the first procedure on another satellite that is not included in the list when the first timer is running (and/or until the first timer has expired).

For example, if (or when) the list is indicated as mandatory (e.g., indicated by the indication), the UE may (be allowed to) access and/or re-attempt the first procedure on another satellite that is included in the list when the first timer is not running (and/or after the first timer expires).

For example, if (or when) the list is indicated as mandatory (e.g., indicated by the indication), the UE may not (be allowed to) access and/or re-attempt the first procedure on another satellite that is included in the list when the first timer is running (and/or until the first timer has expired).

For example, if (or when) the list is indicated as advisory (e.g., indicated by the indication), the UE may (be allowed to) access and/or re-attempt the first procedure on another satellite that is not included in the list when the first timer is not running (and/or after the first timer expires).

For example, if (or when) the list is indicated as advisory (e.g., indicated by the indication), the UE may not (be allowed to) access and/or re-attempt the first procedure on another satellite that is not included in the list when the first timer is running (and/or until the first timer has expired).

For example, if (or when) the list is indicated as advisory (e.g., indicated by the indication), the UE may (be allowed to) access and/or re-attempt the first procedure on another satellite that is included in the list when the first timer is not running (and/or after the first timer expires).

For example, if (or when) the list is indicated as advisory (e.g., indicated by the indication), the UE may not (be allowed to) access and/or re-attempt the first procedure on another satellite that is included in the list when the first timer is running (and/or until the first timer has expired).

For example, if (or when) the list is indicated as mandatory (e.g., indicated by the indication), the UE may (be allowed to) access and/or re-attempt the first procedure on another satellite that is not included in the list when the first timer is not running (and/or after the first timer expires).

For example, if (or when) the list is indicated as mandatory (e.g., indicated by the indication), the UE may (be allowed to) access and/or re-attempt the first procedure on another satellite that is not included in the list when the first timer is running (and/or until the first timer has expired).

For example, if (or when) the list is indicated as mandatory (e.g., indicated by the indication), the UE may not (be allowed to) access and/or re-attempt the first procedure on another satellite that is included in the list when the first timer is not running (and/or after the first timer expires).

For example, if (or when) the list is indicated as mandatory (e.g., indicated by the indication), the UE may (be allowed to) access and/or re-attempt the first procedure on another satellite that is included in the list when the first timer is running (and/or until the first timer has expired).

For example, if (or when) the list is indicated as advisory (e.g., indicated by the indication), the UE may not (be allowed to) access and/or re-attempt the first procedure on another satellite that is not included in the list when the first timer is not running (and/or after the first timer expires).

For example, if (or when) the list is indicated as advisory (e.g., indicated by the indication), the UE may (be allowed to) access and/or re-attempt the first procedure on another satellite that is not included in the list when the first timer is running (and/or until the first timer has expired).

For example, if (or when) the list is indicated as advisory (e.g., indicated by the indication), the UE may not (be allowed to) access and/or re-attempt the first procedure on another satellite that is included in the list when the first timer is not running (and/or after the first timer expires).

For example, if (or when) the list is indicated as advisory (e.g., indicated by the indication), the UE may (be allowed to) access and/or re-attempt the first procedure on another satellite that is included in the list when the first timer is running (and/or until the first timer has expired).

A first list and/or a second list may be included in the second message. The first list and the second list may be provided in different messages. The first list and/or the second list may be (or comprise) a list of satellites (e.g., a list of satellite IDs). The first list or the second list may be (or comprise) an S&F serving satellite(s) list. The first list or the second list may be (or comprise) an S&F monitoring (satellites) list. The first list may indicate a list of satellite(s) as mandatory. The second list may indicate a list of satellite(s) as advisory. The first list may be the list of satellite ID(s) mentioned above. The second list may be the list of satellite ID(s) mentioned above.

The UE may determine whether to access a cell (e.g., when the first timer is not running, upon/after the first timer expiry, and/or when the first timer is running) based on the first list and/or the second list.

For example, the UE may not be allowed to access (at least) a first cell if (at least) the first cell belongs to a satellite not in the first list. The UE may be allowed to access (at least) the first cell if (at least) the first cell belongs to a satellite not in the second list. The UE may be allowed to access (at least) a second cell if (at least) the second cell belongs to a satellite not in the first list and/or not in the second list. The UE may be not allowed to access (at least) a third cell if (at least) the third cell belongs to a satellite not in the first list and/or not in the second list.

The UE may determine whether to bar a cell or consider a cell as barred (e.g., when the first timer is not running, upon/after the first timer expiry, and/or when the first timer is running) based on the first list and/or the second list.

For example, the UE may not consider (at least) a first cell as barred if (at least) the first cell belongs to a satellite not in the first list. The UE may consider (at least) the first cell as barred if (at least) the first cell belongs to a satellite not in the second list. The UE may consider (at least) a second cell as barred if (at least) the second cell belongs to a satellite not in the first list and/or not in the second list. The UE may not consider (at least) a third cell as barred if (at least) the third cell belongs to a satellite not in the first list and/or not in the second list.

The UE may determine whether to consider a cell (e.g., for cell selection and/or reselection) (e.g., when the first timer is not running, upon/after the first timer expiry, and/or when the first timer is running) based on the first list and/or the second list.

For example, the UE may not consider (at least) a first cell if (at least) the first cell belongs to a satellite not in the first list. The UE may consider (at least) the first cell if (at least) the first cell belongs to a satellite not in the second list. The UE may consider (at least) a second cell if (at least) the second cell belongs to a satellite not in the first list and/or not in the second list. The UE may consider (at least) a third cell if (at least) the third cell belongs to a satellite not in the first list and/or not in the second list.

The UE may determine whether to prioritize or de-prioritize a cell (e.g., for cell selection and/or reselection) (e.g., when the first timer is not running, upon/after the first timer expiry, and/or when the first timer is running) based on the first list and/or the second list.

For example, the UE may not prioritize (at least) a first cell if (at least) the first cell belongs to a satellite not in the first list (and/or within or not within the second list). The UE may not prioritize (at least) a first cell if (at least) the first cell belongs to a satellite in the first list (and/or within or not within the second list). The UE may prioritize (at least) the first cell if (at least) the first cell belongs to a satellite not in the second list (and/or within or not within the first list). The UE may prioritize (at least) the first cell if (at least) the first cell belongs to a satellite in the second list (and/or within or not within the first list). The UE may prioritize (at least) a second cell if (at least) the second cell belongs to a satellite not in the first list and/or not in the second list. The UE may prioritize (at least) a third cell if (at least) the third cell belongs to a satellite not in the first list and/or not in the second list.

For example, the UE may not de-prioritize (at least) a first cell if (at least) the first cell belongs to a satellite not in the first list (and/or within or not within the second list). The UE may not de-prioritize (at least) a first cell if (at least) the first cell belongs to a satellite in the first list (and/or within or not within the second list). The UE may de-prioritize (at least) the first cell if (at least) the first cell belongs to a satellite not in the second list (and/or within or not within the first list). The UE may de-prioritize (at least) the first cell if (at least) the first cell belongs to a satellite in the second list (and/or within or not within the first list). The UE may de-prioritize (at least) a second cell if (at least) the second cell belongs to a satellite not in the first list and/or not in the second list. The UE may de-prioritize (at least) a third cell if (at least) the third cell belongs to a satellite not in the first list and/or not in the second list.

The UE may determine whether to perform (or skip) (one or more) idle mode task(s) (e.g., when the first timer is not running, upon/after the first timer expiry, and/or when the first timer is running) based on the first list and/or the second list.

For example, if the first list (and/or the second list) is provided, the UE may (be allowed to) skip (or not perform) (one or more) idle mode task(s). If the first list (and/or the second list) is not provided, the UE may perform (or not skip, or not allowed to skip) (one or more) idle mode task(s). The skipping may depend on whether the UE determines itself in-coverage or out-of-coverage. The determination of in-coverage and/or out-of-coverage may depend on (or be based on) the second list, e.g., the coverage provided by the satellite(s) in the second list. The determination of in-coverage and/or out-of-coverage may depend on (or be based on) the first list, e.g., the coverage provided by the satellite(s) in the first list.

For example, the UE may perform at least one or more of the following (e.g., when the first timer is not running, upon/after the first timer expiry, and/or when the first timer is running):
The UE may not be allowed to access a first cell (e.g., an NTN cell, a cell in S&F mode, a cell belonging to a satellite not in the first list, and/or a cell belonging to a satellite not in the second list);
The UE may be allowed to access a second cell (e.g., an NTN cell, a cell in S&F mode, a cell belonging to a satellite in the first list, and/or a cell belonging to a satellite not in the second list);
The UE may prioritize a third cell (e.g., a TN cell, a (NTN) cell in normal/default/real-time mode, a cell not belonging to a satellite in the first list and the second list, and/or a cell belonging to a satellite in the first list and the second list);
The UE may consider that the TN cell (and/or an NTN cell in normal/default/real-time mode) is prioritized (e.g., over an NTN cell in S&F mode, a cell belonging to a satellite in the first list and/or the second list);
The UE may consider that a cell belonging to a satellite in the second list is prioritized (e.g., over a cell belonging to a satellite not in the second list and/or in the first list); and/or
The UE may consider that a cell belonging to a satellite in the first list (and/or the second list) is prioritized (e.g., over a cell belonging to a satellite not in the first list and/or not in the second list).

An example is shown in FIG. 12.

The first cell and the second cell (and/or the third cell) may be differentiated by whether it is associated to (or belongs to, or corresponds to) a satellite in the first list or not. The first cell (and/or the second cell) and the third cell may be differentiated by whether it is associated to (or belongs to, or corresponds to) a satellite in the second list or not. The first cell may be a cell of a satellite not in the first list and/or not in the second list. The first cell may be a cell of a satellite in the first list and/or in the second list. The second cell may be a cell of a satellite in the first list but not in the second list. The third cell may be a cell of a satellite in the first list and/or in the second list. The third cell may not belong to a satellite in the first list and/or the second list. The first cell, the second cell, and/or the third cell may be an NTN cell. The third cell may be a TN cell. The first cell may be operating in S&F mode. The second cell or the third cell may be operating in S&F mode. The first cell may be operating in normal mode (or default mode, or real-time mode, or not in S&F mode). The second cell or the third cell may be operating in normal mode (or default mode, or real-time mode, or not in S&F mode).

The UE may determine whether to access a cell (e.g., a first cell, a second cell, a third cell, and/or a cell of a satellite not in the list) based on a list (e.g., the list of satellite ID(s)) and/or a timer (e.g., the first timer).

The UE may determine whether to bar a cell or consider a cell as barred (e.g., a first cell, a second cell, a third cell, and/or a cell of a satellite not in the list) based on a list (e.g., the list of satellite ID(s)) and/or a timer (e.g., the first timer).

The UE may determine whether to consider a cell (e.g., for cell selection and/or reselection) (e.g., a first cell, a second cell, a third cell, and/or a cell of a satellite not in the list) based on a list (e.g., the list of satellite ID(s)) and/or a timer (e.g., the first timer).

The UE may determine whether to prioritize or de-prioritize a cell (e.g., for cell selection and/or reselection) (e.g., a first cell, a second cell, a third cell, and/or a cell of a satellite not in the list) based on a list (e.g., the list of satellite ID(s)) and/or a timer (e.g., the first timer).

The UE may determine whether to perform (or skip) (one or more) idle mode task(s) (e.g., a first cell, a second cell, a third cell, and/or a cell of a satellite not in the list) based on a list (e.g., the list of satellite ID(s)) and/or a timer (e.g., the first timer).

For example, the determination may be based on whether the timer is running. If (at least) the timer is running, the UE may not be allowed to attempt (or initiate) the first procedure in the cell, access the cell, bar the cell, consider the cell (e.g., for cell selection and/or reselection), prioritize (or de-prioritize) the cell, and/or perform (or skip) idle mode task(s) on the cell. If (at least) the timer is not running, the UE may be allowed to attempt (or initiate) the first procedure in the cell, access the cell, bar the cell, consider the cell (e.g., for cell selection and/or reselection), prioritize (or de-prioritize) the cell, and/or perform (or skip) idle mode task(s) on the cell.

For example, the determination may be based on whether the timer is running. If (at least) the timer is running, the UE may be allowed to attempt (or initiate) the first procedure in the cell, access the cell, bar the cell, consider the cell (e.g., for cell selection and/or reselection), prioritize (or de-prioritize) the cell, and/or perform (or skip) idle mode task(s) on the cell. If (at least) the timer is not running, the UE may not be allowed to attempt (or initiate) the first procedure in the cell, access the cell, bar the cell, consider the cell (e.g., for cell selection and/or reselection), prioritize (or de-prioritize) the cell, and/or perform (or skip) idle mode task(s) on the cell.

For example, the determination may be based on whether the list is associated with the timer (e.g., the list is provided along with the timer). If (at least) the list is associated with a timer, the UE may not be allowed to attempt (or initiate) the first procedure in the cell, access the cell, bar the cell, consider the cell (e.g., for cell selection and/or reselection), prioritize (or de-prioritize) the cell, and/or perform (or skip) idle mode task(s) on the cell. If (at least) the list is not associated with a timer, the UE may be allowed to attempt (or initiate) the first procedure in the cell, access the cell, bar the cell, consider the cell (e.g., for cell selection and/or reselection), prioritize (or de-prioritize) the cell, and/or perform (or skip) idle mode task(s) on the cell.

For example, the determination may be based on whether the list is associated with the timer (e.g., the list is provided along with the timer). If (at least) the list is associated with a timer, the UE may be allowed to attempt (or initiate) the first procedure in the cell, access the cell, bar the cell, consider the cell (e.g., for cell selection and/or reselection), prioritize (or de-prioritize) the cell, and/or perform (or skip) idle mode task(s) on the cell. If (at least) the list is not associated with a timer, the UE may not be allowed to attempt (or initiate) the first procedure in the cell, access the cell, bar the cell, consider the cell (e.g., for cell selection and/or reselection), prioritize (or de-prioritize) the cell, and/or perform (or skip) idle mode task(s) on the cell.

The UE may determine whether to access a cell (e.g., a first cell, a second cell, a third cell, and/or a cell of a satellite not in the list) based on the message where the list (e.g., the list of satellite ID(s)) and/or the wait time is received (e.g., when the first timer is running, after the first timer expires).

The UE may determine whether to bar a cell or consider a cell as barred (e.g., a first cell, a second cell, a third cell, and/or a cell of a satellite not in the list) based on the message where the list (e.g., the list of satellite ID(s)) and/or the wait time is received (e.g., when the first timer is running, after the first timer expires).

The UE may determine whether to consider a cell (e.g., for cell selection and/or reselection) (e.g., a first cell, a second cell, a third cell, and/or a cell of a satellite not in the list) based on the message where the list (e.g., the list of satellite ID(s)) and/or the wait time is received (e.g., when the first timer is running, after the first timer expires).

The UE may determine whether to prioritize or de-prioritize a cell (e.g., for cell selection and/or reselection) (e.g., a first cell, a second cell, a third cell, and/or a cell of a satellite not in the list) based on the message where the list (e.g., the list of satellite ID(s)) and/or the wait time is received (e.g., when the first timer is running, after the first timer expires).

The UE may determine whether to perform (or skip) (one or more) idle mode task(s) (e.g., a first cell, a second cell, a third cell, and/or a cell of a satellite not in the list) based on the message where the list (e.g., the list of satellite ID(s)) and/or the wait time is received (e.g., when the first timer is running, after the first timer expires).

For example, the determination may be based on which message provides the list (or the wait time). If (at least) the list (or the wait time) is provided in a first message (e.g., a reject message), the UE may not be allowed to attempt (or initiate) the first procedure in the cell, access the cell, bar the cell, consider the cell (e.g., for cell selection and/or reselection), prioritize (or de-prioritize) the cell, and/or perform (or skip) idle mode task(s) on the cell (e.g., when the first timer is running, after the first timer expires). If (at least) the list (or the wait time) is provided in a second message (e.g., an accept message), the UE may be allowed to attempt (or initiate) the first procedure in the cell, access the cell, bar the cell, consider the cell (e.g., for cell selection and/or reselection), prioritize (or de-prioritize) the cell, and/or perform (or skip) idle mode task(s) on the cell (e.g., when the first timer is running, after the first timer expires).

For example, the determination may be based on which message provides the list (or the wait time). If (at least) the list (or the wait time) is provided in a first message (e.g., a reject message), the UE may be allowed to attempt (or initiate) the first procedure in the cell, access the cell, bar the cell, consider the cell (e.g., for cell selection and/or reselection), prioritize (or de-prioritize) the cell, and/or perform (or skip) idle mode task(s) on the cell (e.g., when the first timer is running, after the first timer expires). If (at least) the list (or the wait time) is provided in a second message (e.g., an accept message), the UE may not be allowed to attempt (or initiate) the first procedure in the cell, access the cell, bar the cell, consider the cell (e.g., for cell selection and/or reselection), prioritize (or de-prioritize) the cell, and/or perform (or skip) idle mode task(s) on the cell (e.g., when the first timer is running, after the first timer expires).

For example, the determination may be based on whether the list (or the wait time) is provided in a first message (e.g., a reject message) or not. If (at least) the list (or the wait time) is provided in the first message, the UE may not be allowed to attempt (or initiate) the first procedure in the cell, access the cell, bar the cell, consider the cell (e.g., for cell selection and/or reselection), prioritize (or de-prioritize) the cell, and/or perform (or skip) idle mode task(s) on the cell (e.g., when the first timer is running, after the first timer expires). If (at least) the list (or the wait time) is not provided in the first message, the UE may be allowed to attempt (or initiate) the first procedure in the cell, access the cell, bar the cell, consider the cell (e.g., for cell selection and/or reselection), prioritize (or de-prioritize) the cell, and/or perform (or skip) idle mode task(s) on the cell (e.g., when the first timer is running, after the first timer expires).

The first message may be (or comprise) an Attach reject message, service reject message, and/or TAU reject message.

The second message may be (or comprise) an Attach accept message, service accept message, and/or TAU accept message.

The first cell (or the first network) may be (or comprise) the cell (or network) where the response message of the first procedure, the wait time(r), and/or the list of satellite ID(s) is received.

In one or more examples, to access a cell may be (or comprise) to camp on the cell, to select the cell (e.g., in cell selection process), to reselect the cell (e.g., in cell reselection process), to connect to the cell, to establish a connection to the cell, and/or to attempt (or re-attempt) a first procedure on the cell.

In one or more examples, idle mode task(s) may be (or comprise) (RRC) idle mode measurement, cell selection evaluation, cell reselection evaluation, and/or paging monitoring.

In one or more examples, to prioritize (or de-prioritize) a cell belonging to a satellite may be (or comprise) to prioritize (or de-prioritize) the frequency served by the satellite.

In one or more examples, “if” may be replaced by “if at least” or “when”.

When the first timer is running, the UE may initiate a second procedure (e.g., to a second network). The UE may initiate the second procedure in response to (or when/upon/if/due to) the UE (determines to) (re)select (or connect to/attach to/register to/subscribe a service to) another network (e.g., the second network), e.g., for normal service.

The second procedure may be for normal service. The second procedure may be the same as the first procedure. The second procedure may be different from the first procedure. The second procedure may be (or comprise) an attach procedure. The second procedure may be (or comprise) a TAU (tracking area update) procedure. The second procedure may be (or comprise) a registration procedure. The second procedure may be (or comprise) a service request procedure.

The UE may transmit a third message (e.g., a request message) to a network (e.g., the second network), e.g., during the second procedure. The third message may (at least) indicate that the UE requests normal service (e.g., other than S&F operation). The third message may (at least) indicate a request in normal service (e.g., other than S&F operation). The third message may be (or comprise) an attach request. The third message may be (or comprise) a TAU request. The third message may be (or comprise) a registration request. The third message may be (or comprise) a service request.

The UE may receive a fourth message (e.g., a response message) from a network (e.g., the second network), e.g., during the second procedure, in response to transmitting the third message. The fourth message may (at least) indicate that the network enables (or activates/starts) normal service (e.g., other than S&F operation). The fourth message may be (or comprise) an accept message. The fourth message may be (or comprise) a reject message.

The UE may perform at least a first action(s) upon (or when/if/in response) expiry of the first timer. The UE may perform at least the first action(s) if (at least) the second procedure is not ongoing.

The UE may not perform at least the first action(s) during the second procedure, e.g., upon expiry of the first timer, when the first timer is not running. The UE may not perform at least the first action(s) if (at least) the first timer expires during the second procedure, e.g., upon expiry of the first timer, when the first timer is not running.

The UE may determine (whether) to perform at least the first action(s) (e.g., upon expiry of the first timer, when the first timer is not running) based on (at least) whether the second procedure is ongoing (or not).

The UE may perform at least the first action(s) upon (or when/if/in response to) the second procedure is completed (or terminated, or cancelled), e.g., if (at least) the first timer expires during the second procedure. The second procedure may be completed (or terminated) successfully. The second procedure may be completed (or terminated) unsuccessfully.

The UE may consider the first timer as expired at the end of the second procedure, e.g., if the first timer expires during the second procedure.

The UE may consider the first timer as expired upon (or when/if/in response to) the second procedure is completed (or terminated, or cancelled), e.g., if the first timer expires during the second procedure. The second procedure may be completed (or terminated) successfully. The second procedure may be completed (or terminated) unsuccessfully.

The UE may perform at least the first action(s) upon (or when/if/in response to) the UE receiving the fourth message, e.g., if the first timer expires during the second procedure.

The first action(s) may be (or comprise) one or more of the following:
Initiate (or re-initiate) the first procedure (e.g., for S&F operation, or via the first network);
Transmit (or retransmit) the first message (e.g., for S&F operation, or via the first network);
Allow (or enable) the UE to (re)select (or connect, or attach, or register, or subscribe service) to network (e.g., the first network); and/or
Allow (or enable) the UE to continue (or resume) the first procedure (e.g., for S&F operation, or via the first network).

When the first timer is running, the UE may be prohibited (or restricted) to initiate (or trigger) the first procedure (and/or transmit the first message), e.g., to the first network or (at least) the first cell, and/or for S&F operation. When the first timer is running, the UE may be prohibited (or restricted) to (re)select (or connect, or attach, or register, or subscribe service) to network, e.g., the second network, and/or for S&F operation. The prohibition (or restriction) may be applied to the network indicated by the list of satellite ID(s). The prohibition (or restriction) may not be applied to the network not indicated by the list of satellite ID(s).

When the first timer is running, the UE may be allowed (or may not be prohibited/restricted) to initiate (or trigger) the second procedure (and/or transmit the third message), e.g., to the second network, and/or for normal service (e.g., other than S&F operation). When the first timer is running, the UE may be allowed (or may not be prohibited/restricted) to (re)select (or connect, or attach, or register, or subscribe service) to a network, e.g., the second network, and/or for normal service (e.g., other than S&F operation).

When the first timer is not running, the UE may be allowed to initiate (or trigger) the first procedure (and/or transmit the first message), e.g., to the first network, and/or for S&F operation. When the first timer is not running, the UE may be allowed to (re)select (or connect, or attach, or register, or subscribe service) to the network, e.g., the second network, and/or for S&F operation.

The network (e.g., the first network, the second network) may be PLMN.

The network (e.g., the first network, the second network) may be a satellite NW.

The network (e.g., the first network, the second network) may be an NTN.

The network (e.g., the first network, the second network) may be a TN.

The network (e.g., the first network, the second network) may be a cell (e.g., NTN cell, satellite cell, E-UTRAN cell) or a group of cells.

The first network and the second network may be of different network types (e.g., TN, NTN).

The first network and the second network may be of different PLMNs.

The first network and the second network may provide different types of services (e.g., S&F operation, normal service).

The first network may be (or comprise) a network (or network node) indicated by (or inside) the list of satellite ID(s).

The second network may be (or comprise) network (or network node) not indicated by (or outside) the list of satellite ID(s).

The first procedure and/or the second procedure may be (or comprise): a registration (or deregistration) procedure, attach procedure, detach procedure, tracking area update procedure, Protocol Data Unit (PDU) session establishment (or modification) procedure, NAS transport procedure, Packet Data Network (PDN) connectivity procedure, and/or service request procedure The first procedure and/or the second procedure may be (or comprise): an RRC connection establishment procedure, RRC connection re-establishment procedure, and/or RRC connection resume procedure.

The first procedure may be for S&F operation, for non-S&F operation, or for normal service.

The second procedure may be for S&F operation, for non-S&F operation, or for normal service.

The first network may be initially operated in S&F and/or provide S&F service. The first network may provide (or broadcast) an indication of S&F operation, e.g., in system information. The indication may indicate that the first network is in S&F mode, using S&F operation, and/or providing S&F service. The UE may receive a configuration of the wait time (or the first timer) from the first network, e.g., in the second message, during the first procedure, and/or while the first network is under S&F operation.

The operation mode may include: S&F mode/operation/service, normal (or default) mode/operation/service.

Throughout the present disclosure, the following terms may be interchangeable: S&F, S&F mode, S&F operation, S&F service.

Throughout the present disclosure, the following terms may be interchangeable: normal mode, default mode, normal service, normal operation, real-time mode, real-time operation.

A UE and/or a network node may be in S&F mode (or use S&F operation) if at least one or more of the following conditions are fulfilled:
The feeder link (of the UE and/or the network node) is not available;
An indication of S&F mode (and/or to enable S&F mode) is received (or transmitted);
A configuration related to S&F mode (and/or enabled) is received (or transmitted);
and/or
S&F mode (of the UE and/or the network node) is enabled and/or activated.

The UE and/or the network node may be in normal mode (e.g., compared to S&F mode) if at least one or more of the following conditions are fulfilled:
The feeder link (of the UE and/or the network node) is available;
No indication of S&F mode is received (or transmitted);
An indication to disable (or deactivate) S&F mode is received (or transmitted);
No configuration related to S&F mode (and/or enabled) is received (or transmitted);
A configuration to disable (or deactivate) S&F mode is received (or transmitted); and/or
S&F mode (of the UE and/or the network node) is disabled and/or deactivated.

The UE and/or the network node may enter S&F mode from normal mode, and/or leave S&F mode to enter normal mode.

When the UE and/or the network node is in S&F mode (or use S&F operation), at least one or more of the following may be performed:
The UE may know (or be informed by NW) that the NW is (or starts) using S&F to handle data (and/or signaling);
The UE may initiate a procedure to request (or indicate) the (satellite) NW to use S&F to handle data (and/or signaling);
The UE may perform data (and/or signaling) transmission that will be handled by S&F in the (satellite) NW; and/or
The UE may (be ready to) perform data (and/or signaling) reception that is stored in the (satellite) NW.

One or more configurations (/indication/parameter) related to S&F may be provided to the UE (e.g., from the network node, e.g., in addition to the information). The configuration (and/or the indication/parameter) related to S&F (or S&F configuration) may be associated (or specific) to an object. The object may be (or comprise) a UE, a cell, a connection (e.g., RRC connection, NAS connection), a PDU session, and/or a Quality of Service (QoS) flow. The NW may indicate (or configure) which object that the configuration (and/or the indication/parameter) is associated to/with. The NW may provide (at least) one configuration (and/or the indication/parameter) to (at least) one object.

The configuration (and/or the indication/parameter) related to S&F may be/comprise/be used for/indicate one or more of the following:

### S&F Mode Indication

The indication may (at least) indicate whether the S&F operation is enabled or not (e.g., in the cell, for the UE, to the NW). The indication may (at least) indicate whether a feeder link of the NW is available or not. The indication may (at least) indicate whether the UE is allowed to use S&F operation (e.g., in the cell, to the NW);
The UE may determine (whether) to use S&F operation based on (at least) the indication. For example, if the UE receives the indication, the UE may consider the S&F operation is enabled (and/or activated). If the UE does not receive the indication, the UE may consider the S&F operation is not enabled (and/or activated). If the UE receives the indication, the UE may be allowed to use the S&F operation. If the UE does not receive the indication, the UE may not be allowed to use the S&F operation. The UE may be of a specific UE type. The UE type is illustrated below; and/or

### UE Type

The configuration may (at least) indicate what (type of) UE is allowed to use S&F operation. The configuration may (at least) indicate what (type of) UE is allowed to perform transmission and/or reception to the NW (e.g., using S&F operation). The transmission and/or reception may be User Plane (UP) data and/or Control Pane (CP) signaling;
The UE type (e.g., a first type) may be based on (or identified by/represented by/specific to) UE capability, UE mobility, QoS characteristic of UE, UE status. The UE type may be (or comprise) (at least) an enhanced Machine-Type Communication ((e)MTC) UE, Narrowband (NB)-Internet of Things (IoT) UE, Reduced Capability (RedCap) UE, UE supporting NR, UE supporting 5G Core (5GC), UE supporting NTN, UE supporting regenerative payload, UE with Global Navigation Satellite System (GNSS), and/or UE supporting S&F operation. The UE type may be (or comprise) (at least) a stationary UE, low mobility UE, and/or UE within a limited area. The UE type may be (or comprise) (at least) a UE with low QoS requirement, and/or UE without Ultra-Reliable Low-Latency Communication (URLLC);
The configuration may (also) be pre-configured. For example, a first type of UE is allowed to use S&F operation if the UE receives the S&F mode indication. For example, a first type of UE is (always) allowed to use S&F operation;
The UE may determine (whether) to use S&F operation based on (at least) the configuration. For example, if the UE receives the configuration and/or the UE belongs to a UE type in the configuration (or pre-configuration), the UE may consider the S&F operation is enabled (and/or activated, and/or allowed). If the UE receives the configuration and/or the UE does not belong to a UE type in the configuration (or pre-configuration), the UE may consider the S&F operation is not enabled (and/or activated, and/or allowed). If the UE does not receive the configuration, the UE may consider the S&F operation is not enabled (and/or activated, and/or allowed); and/or

### Traffic Type

The configuration may (at least) indicate what (type of) traffic is allowed to use S&F operation. The configuration may (at least) indicate what (type of) traffic is allowed to be transmitted to the NW (e.g., using S&F operation). The traffic may be (UP) data and/or (CP) signaling. The traffic may be Access Stratum (AS) level and/or NAS level. The configuration may (also) be pre-configured. The configuration may be based on QoS requirement of the traffic (or the traffic type);
The traffic (or the traffic type) may be based on (or identified by/represented by/specific to) QoS flow, PDU session, radio bearer (Signaling Radio Bearer (SRB) and/or Data Radio Bearer (DRB)), Radop Link Control (RLC) bearer, and/or logical channel;
Explicit configuration may be used for some traffic (or traffic type), and implicit configuration (or pre-configuration) may be used for some (other) traffic (or traffic type). For example, whether a first traffic (or traffic type) is allowed to use S&F operation may be based on the configuration. Whether a second traffic (or traffic type) is allowed to use S&F operation may be based on pre-configuration (e.g., allowed, not allowed, without configuration);
The UE may determine (whether) to use S&F operation (e.g., for a specific traffic or traffic type) based on (at least) the configuration. For example, if the UE receives the configuration and/or the traffic of the UE is included in the configuration (or pre-configuration), the UE may consider the S&F operation is (or is not) enabled (and/or activated, and/or allowed), e.g., for the traffic. If the UE receives the configuration and/or the traffic of the UE is not included in the configuration (or pre-configuration), the UE may consider the S&F operation is not (or is) enabled (and/or activated, and/or allowed), e.g., for the traffic. If the UE receives the configuration and/or the traffic of the UE could fulfill the condition/limitation/restriction/requirement of the configuration (or pre-configuration), the UE may consider the S&F operation is enabled (and/or activated, and/or allowed), e.g., for the traffic. If the UE receives the configuration and/or the traffic of the UE cannot fulfill the condition/limitation/restriction/requirement of the configuration (or pre-configuration), the UE may consider the S&F operation is not (or is) enabled (and/or activated, and/or allowed), e.g., for the traffic. If the UE does not receive the configuration, the UE may consider the S&F operation is (or is not) enabled (and/or activated, and/or allowed), e.g., for every (or all) traffic of the UE;
If the UE considers S&F operation is allowed/enabled/activated for a traffic, the UE may perform transmission (and/or reception) of the traffic (e.g., using S&F operation), initiate a procedure to (or for) performing transmission (and/or reception) of the traffic (e.g., using S&F operation), and/or to request permission/establishment/resource for the traffic (e.g., using S&F operation). The procedure may be a registration procedure (e.g., for initial and/or mobility update), service request procedure, PDU session establishment (or modification) procedure; and/or

### QoS Parameter

The parameter may be used by the UE (e.g., based on at least the parameter) to determine (at least) whether QoS requirement of a UE request (e.g., for a service, connection, PDU session, and/or QoS flow) can be fulfilled. The parameter may be used by the UE (e.g., based on at least the parameter) to (at least) determine whether to initiate a UE request (e.g., for a service, connection, PDU session, and/or QoS flow);
The parameter may be (at least) based on (or identified by/represented by/specific to) a UE, a connection, a service, a PDU session, and/or a QoS flow. The configuration may (at least) indicate what type of UE, connection, service, PDU session, and/or QoS flow is associated to the parameter. The parameter may be (at least) based on (or identified by/represented by/specific to) a radio bearer (SRB and/or DRB), RLC bearer, and/or logical channel. The configuration may (at least) indicate what type of radio bearer, RLC bearer, and/or logical channel is associated to the parameter;
The parameter may be (or comprise) (at least) a QoS Flow Identifier (QFI), 5G QoS Identifier (5QI), Allocation and Retention Priority (ARP), resource type, priority level, packet error rate, averaging window, delay budget (e.g., packet delay budget), and/or data volume (maximum data burst volume);
The parameter may (at least) indicate QoS (related) levels/requirements/characteristic(s) allowed to use S&F operation. The parameter may (at least) indicate a maximum QoS level (e.g., latency) that the NW can fulfill. The parameter may (at least) indicate how long the data (or signaling) received from UE is expected to be stored by the NW before being delivered. The parameter may (at least) indicate how long the response of a UE request is (expected to be) transmitted (or received);
The UE may determine (whether) to use S&F operation (e.g., for a specific object, for a service, for a PDU session) based on (at least) the configuration. For example, if the UE receives the configuration and/or the object of the UE (or the service, or the PDU session) is included in the configuration (or pre-configuration), the UE may consider the S&F operation is (or is not) enabled (and/or activated, and/or allowed), e.g., for the object, for the service, and/or for the PDU session. If the UE receives the configuration and/or the object of the UE (or the service, or the PDU session) is not included in the configuration (or pre-configuration), the UE may consider the S&F operation is not (or is) enabled (and/or activated, and/or allowed), e.g., for the object, for the service, and/or for the PDU session. If the UE receives the configuration and/or the object of the UE (or the service, or the PDU session) could fulfill the condition/limitation/restriction/requirement of the configuration (or pre-configuration), the UE may consider the S&F operation is enabled (and/or activated, and/or allowed), e.g., for the object, for the service, and/or for the PDU session. If the UE receives the configuration and/or the object of the UE (or the service, or the PDU session) cannot fulfill the condition/limitation/restriction/requirement of the configuration (or pre-configuration), the UE may consider the S&F operation is not (or is) enabled (and/or activated, and/or allowed), e.g., for the object, for the service, and/or for the PDU session. If the UE does not receive the configuration, the UE may consider the S&F operation is (or is not) enabled (and/or activated, and/or allowed), e.g., for every (or all) object of the UE (or the service, or the PDU session);
If the UE considers S&F operation is allowed/enabled/activated for an object (or a service, or a PDU session), the UE may perform transmission (and/or reception) of the object (or the service, or the PDU session) (e.g., using S&F operation), initiate a procedure to (or for) performing transmission (and/or reception) of the object (or the service, or the PDU session) (e.g., using S&F operation), and/or to request permission/establishment/resource for the object (or the service, or the PDU session) (e.g., using S&F operation). The procedure may be a registration procedure (e.g., for initial and/or mobility update), service request procedure, PDU session establishment (or modification) procedure;
To determine whether a service (or PDU session, or UE) is allowed to use S&F operation, at least an object of the service (or PDU session, or UE) needs to fulfill the configured QoS. For example, if no object of the service (or PDU session, or UE) fulfills the configured QoS, the UE may not be allowed to use S&F operation for the service (or PDU session, or UE). If every object of the service (or PDU session, or UE) fulfills the configured QoS, the UE may be allowed to use S&F operation for the service (or PDU session, or UE). If some object(s) of the service (or PDU session, or UE) (e.g., a first object) fulfills the configured QoS and some other object(s) of the service (or PDU session, or UE) (e.g., a second object) doesn't fulfills the configured QoS, the UE may be allowed to use S&F operation for the first object and not allowed to use S&F operation for the second object. If some object(s) of the service (or PDU session, or UE) (e.g., a first object) fulfills the configured QoS and some other object(s) of the service (or PDU session, or UE) (e.g., a second object) doesn't fulfills the configured QoS, the UE may not be allowed to use S&F operation for the service (or PDU session, or UE) (e.g., including the first object and the second object). If some object(s) of the service (or PDU session, or UE) (e.g., a first object) fulfills the configured QoS and some other object(s) of the service (or PDU session, or UE) (e.g., a second object) does not fulfill the configured QoS, the UE may be allowed to use S&F operation for the service (or PDU session, or UE) (e.g., including the first object and the second object);
The object may be (or comprise) (at least) a connection, a service, a PDU session, and/or a QoS flow. The object may be (or comprise) (at least) a radio bearer, RLC bearer, and/or logical channel; and/or

### Data Volume

The configuration may (at least) indicate data volume limitation allowed to use S&F operation. The configuration may (at least) indicate how much data that can be transmitted to the NW (e.g., using S&F operation). The data may be (or comprise) UP data and/or CP signaling. The data may be AS level and/or NAS level;
The configuration may be (at least) based on (or identified by/represented by/specific to) a UE, a connection, a service(s), a PDU session(s), and/or a QoS flow(s). The configuration may (at least) indicate what (or which) UE, connection(s), service(s), PDU session(s), and/or QoS flow(s) is associated to the configuration. The configuration may be (at least) based on (or identified by/represented by/specific to) a radio bearer(s) (SRB and/or DRB), RLC bearer(s), and/or logical channel(s). The configuration may (at least) indicate what (or which) radio bearer(s), RLC bearer(s), and/or logical channel(s) is associated to the parameter;
The UE may determine (whether) to use S&F operation (e.g., for a specific object) based on (at least) the configuration. The UE may determine (whether) to stop S&F operation (e.g., for a specific object) based on (at least) the configuration. The UE may determine (whether) S&F operation (e.g., for a specific object) can continue based on (at least) the configuration;
The object may be (or comprise) (at least) a UE, a connection, a service, a PDU session, and/or a QoS flow. The object may be (or comprise) (at least) a radio bearer, RLC bearer, and/or logical channel;
For example, if the UE receives the configuration and/or the traffic of the UE (e.g., for the object) has not exceeded the data volume, the UE may (be allowed to) use S&F operation, e.g., for the traffic. If the UE receives the configuration and/or the traffic of the UE (e.g., for the object) has exceeded the data volume, the UE may not (be allowed to) use S&F operation, e.g., for the traffic. If the UE does not receive the configuration, the UE may consider there is no data volume limitation to use S&F operation, e.g., for the UE, for the object;
If the UE considers that S&F operation is allowed (e.g., for a traffic), the UE may perform (or continue) transmission (and/or reception) of the traffic (e.g., using S&F operation), initiate (or continue) a procedure to (or for) performing transmission (and/or reception) of the traffic (e.g., using S&F operation), and/or to request permission/establishment/resource for the traffic (e.g., using S&F operation). The procedure may be a registration procedure (e.g., for initial and/or mobility update), service request procedure, PDU session establishment (or modification) procedure;
If the UE has transmitted data exceeding the data volume, the UE may stop the S&F operation, stop transmitting data, stop the (ongoing) procedure. If the UE has transmitted data exceeding the data volume, the UE may transmit an indication to the NW (e.g., indicating that the data volume limitation is reached), initiate a (RRC and/or NAS) connection release (request) procedure, initiate a de-registration procedure, and/or initiate a PDU session release (or modification) procedure (e.g., to release a PDU session). If the UE has transmitted data exceeding the data volume, the UE may release a (RRC and/or NAS) connection, and/or go to (RRC and/or NAS) idle mode (e.g., RRC_IDLE, Connection Management (CM)_IDLE).

The NW (or network node) may be a satellite NW. The satellite NW may be a network node, a CN node, a RAN node, Access and Mobility Management Function (AMF), Session Management Function (SMF), MME, RAN, NG-RAN, eNB, gNB, a portion of the above, and/or a combination of the above.

The NW (or network node) may be ground NW. The ground NW may be a network node, a CN node, a RAN node, AMF, SMF, MME, RAN, NG-RAN, eNB, gNB, a portion of the above, and/or a combination of the above.

The satellite NW and the ground NW may be mutually exclusive.

The NW (or network node) may be a cell. The NW may be a serving cell. The NW may be a neighbor cell. The NW may be a source cell. The NW may be a target cell.

The UE may be in RRC connected mode. The UE may be in RRC idle mode. The UE may be in RRC inactive mode.

The UE may be in CM idle state. The UE may be in CM connected state.

The UE may be in Register Management (RM) deregistered state. The UE may be in RM registered state.

The UE may be in a cell of an NTN. The UE may be connected to a cell of an NTN. The UE may be connected to a LEO, GEO, MEO, HEO, and/or HAPS.

The UE may be referred to the UE, an RRC entity of the UE or a Medium Access Control (MAC) entity of the UE.

The UE may be an NR device. The UE may be a NR-light device. The UE may be a reduced capability device. The UE may be a mobile phone. The UE may be a wearable device. The UE may be a sensor. The UE may be a stationary device.

The NW may be a network node. The NW may be a base station. The NW may be an access point. The NW may be an eNB. The NW may be a gNB. The NW may be a gateway. The NW may be a PLMN.

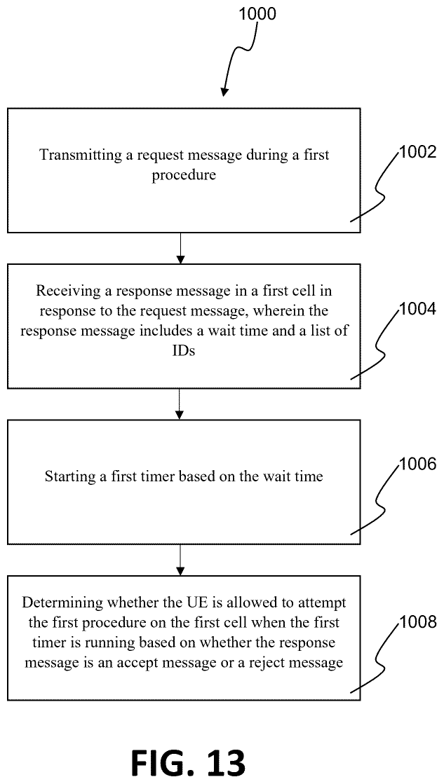

Referring to FIG. 13, with this and other concepts, systems, and methods of the present invention, a method 1000 for a UE in a wireless communication system comprises transmitting a request message during a first procedure (step 1002), receiving a response message in a first cell in response to the request message, wherein the response message includes a wait time and a list of satellite IDs (step 1004), starting a first timer based on the wait time (step 1006), and determining whether the UE is allowed to attempt the first procedure on the first cell when the first timer is running based on whether the response message is an accept message or a reject message (step 1008).

In various embodiments, the UE is not allowed to attempt the first procedure on the first cell if the response message is a reject message.

In various embodiments, the UE is allowed to attempt the first procedure on the first cell if the response message is an accept message.

In various embodiments, the first procedure is an attach procedure, a TAU procedure, or a service request procedure.

In various embodiments, when the first timer is running, the UE is prohibited or restricted from initiating the first procedure to a second cell for S&F operation.

In various embodiments, when the first timer expires, the UE is allowed to initiate the first procedure to the second cell for S&F operation.

In various embodiments, the UE initiates the first procedure in the first cell.

In various embodiments, the UE indicates it supports S&F operation during the first procedure.

In various embodiments, the first cell provides an S&F mode indication to the UE.

In various embodiments, the S&F mode indication indicates whether S&F operation is enabled or not.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) transmit a request message during a first procedure; (ii) receive a response message in a first cell in response to the request message, wherein the response message includes a wait time and a list of satellite IDs; (iii) start a first timer based on the wait time; and (iv) determine whether the UE is allowed to attempt the first procedure on the first cell when the first timer is running based on whether the response message is an accept message or a reject message. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of a User Equipment (UE), comprising:
transmitting a request message during a first procedure;
receiving a response message in a first cell in response to the request message, wherein the response message includes a wait time and a list of satellite identities (IDs);
starting a first timer based on the wait time; and
determining whether the UE is allowed to attempt the first procedure on the first cell when the first timer is running based on whether the response message is an accept message or a reject message.

2. The method of claim 1, wherein the UE is not allowed to attempt the first procedure on the first cell if the response message is a reject message.

3. The method of claim 1, wherein the UE is allowed to attempt the first procedure on the first cell if the response message is an accept message.

4. The method of claim 1, wherein the first procedure is an attach procedure, a Tracking Area Update (TAU) procedure, or a service request procedure.

5. The method of claim 1, wherein when the first timer is running, the UE is prohibited or restricted from initiating the first procedure to a second cell for S&F operation.

6. The method of claim 1, wherein when the first timer expires, the UE is allowed to initiate the first procedure to the second cell for Store and Forward (S&F) operation.

7. The method of claim 1, wherein the UE initiates the first procedure in the first cell.

8. The method of claim 1, wherein the UE indicates it supports S&F operation during the first procedure.

9. The method of claim 1, wherein the first cell provides an S&F mode indication to the UE.

10. The method of claim 9, wherein the S&F mode indication indicates whether S&F operation is enabled or not.

11. A User Equipment (UE), comprising:
a memory; and
a processor operatively coupled with the memory, wherein the processor is configured to execute a program code to:
transmit a request message during a first procedure;
receive a response message in a first cell in response to the request message, wherein the response message includes a wait time and a list of satellite Identities (IDs);
start a first timer based on the wait time; and
determine whether the UE is allowed to attempt the first procedure on the first cell when the first timer is running based on whether the response message is an accept message or a reject message.

12. The UE of claim 11, wherein the UE is not allowed to attempt the first procedure on the first cell if the response message is a reject message.

13. The UE of claim 11, wherein the UE is allowed to attempt the first procedure on the first cell if the response message is an accept message.

14. The UE of claim 11, wherein the first procedure is an attach procedure, a Tracking Area Update (TAU) procedure, or a service request procedure.

15. The UE of claim 11, wherein when the first timer is running, the UE is prohibited or restricted from initiating the first procedure to a second cell for S&F operation.

16. The UE of claim 11, wherein when the first timer expires, the UE is allowed to initiate the first procedure to the second cell for Store and Forward (S&F) operation.

17. The UE of claim 11, wherein the UE initiates the first procedure in the first cell.

18. The UE of claim 11, wherein the UE indicates it supports S&F operation during the first procedure.

19. The UE of claim 11, wherein the first cell provides an S&F mode indication to the UE.

20. The UE of claim 19, wherein the S&F mode indication indicates whether S&F operation is enabled or not.
